(19) United States
(12) Patent Application Publication
(10) Pub. No.: US 2014/0337045 A1
(43) Pub. Date: Nov. 13, 2014

(54) Remote Notification System

(71) Applicants: Cheryl Ann Scrivner, Denver, CO (US); Michael Esposito, Arvada, CO (US)

(72) Inventors: Cheryl Ann Scrivner, Denver, CO (US); Michael Esposito, Arvada, CO (US)

(21) Appl. No.: 14/242,874

(22) Filed: Apr. 2, 2014

Related U.S. Application Data
(60) Provisional application No. 61/822,397, filed on May 12, 2013.

(51) Int. Cl. G06F 19/00

(52) U.S. Cl. CPC G06F 19/3418
USPC 705/2

(57) ABSTRACT

A wireless remote notification system for use by a medical practitioner having a wireless capable tablet personal computer, to monitor each one of a group of patients in an infusion treatment center, the tablet personal computer wirelessly connects to and displays each patient's intravenous fluid pump output of treatment session time, intravenous fluid type, intravenous fluid conditions of gas content, fluid pressure, and flow-rate, including an alarm for abnormal intravenous fluid conditions. The tablet personal computer giving the medical practitioner an instant notice of a particular patient's abnormal intravenous fluid condition facilitating the medical practitioner the ability to quickly take corrective action and potentially deactivate the alarm quickly, thus reducing patient aggravation from their intravenous fluid condition alarms and adjacent patient intravenous fluid condition alarms.

### RELATED PATENT APPLICATION

This application claims the benefit of U.S. provisional patent application Ser. No. 61/822,397 filed on May 12, 2013 by Cheryl Ann Scrivner of Denver, Colo., U.S. and Michael Esposito of Arvada, Colo., U.S.

### FIELD OF THE INVENTION

The present invention generally relates to wireless based communications networks that can be used in a medical or an industrial area. More particularly, the present invention presents a system for conveying patient intravenous (IV) infusion information/data directly from their IV infusion pump to their assigned nurse during their outpatient infusion treatments.

### DESCRIPTION OF THE RELATED ART

Typically infusion centers include a large open room or alternatively a long corridor with numerous “infusion bays”, each having a reclining chair and IV pole(s) with attached IV pump(s). Usually the infusion bays are aligned in very close proximity to one another due to space limitations, with large infusion centers having upwards of fifty infusion bays typically staffed with ten to twelve registered nurses. An individual patient infusion can take as little as fifteen minutes or up to several hours depending upon the complexity and the number of infusions ordered. The infusion pumps have set parameters which will locally (at the IV pump) audibly alarm and give a visual indication alarm for various patient parameters deviating from set standards of the infusion fluid typically of pressure, flow rate, total flow, flow interruption, gas in the infusion liquid, infusion complete, low IV pump battery, and the like. These IV pump alarms can happen quite frequently from something as simple as the patient inadvertently bending their arm that the IV feed is connected to causing the flexible IV tubing to bend thereby momentarily blocking infusion fluid flow in the IV tubing, which will cause the IV fluid pressure to rise or flow to stop-thus activating the IV pump alarm, in addition when the total amount of IV fluid has completed flowing into the patient the alarm also activates. These IV pump alarm issues are also relevant to the inpatient setting as well, where nurses are responsible for multiple patients in different hospital rooms.

The problem with numerous alarms, this being compounded by up to fifty IV pump units in a single room alarming almost continuously thus causing significant noise pollution for both patients and staff, further these continuously sounding alarms cause unease and agitation in patients who are inherently already uncomfortable being tied down via the infusion process plus, in addition the patients are typically not feeling well and just want to relax or sleep, of which the almost continuous IV pump alarming prevents-especially the audio alarms. Another problem is that the IV pump alarms are very vague, when a particular IV pump alarm activates that is associated with a particular patient, it is difficult to tell which patient's IV pump alarm is activated, especially with adjacent patient's IV pump alarms activating simultaneously with the nurse literally having to run around the entire infusion center room trying to determine the particular IV pump that is alarming that is associated with a particular patient. This scenario is a significant source of interruption to the nurse's workflow that interferes with charting-record keeping or spending time with patients, which in turn results in decreased productivity and increased risk for error on the part of the nurse.

There are typically two problems with the IV pump audible alarms in particular, firstly they are loud and disruptive, oftentimes many IV pumps will alarm simultaneously, creating significant noise pollution for both patients and nursing staff. The noisy environment means that some audible alarms go unheard because the nursing staff literally cannot hear them or discern them on an individual basis. This is particularly troublesome when the patient is in a room distant from the nurse's station, or the patient has the room door closed or they are in the bathroom. That's the multiplicity of audio alarms again adds unnecessary stress and sleep deprivation which is detrimental to the patient healing process. The second problem is with the audio alarms is that they are vague and nondescript. It is difficult for the nurses to discern which patient's infusion pump alarm is actually going off, especially when several infusion pump audio alarms are alarming simultaneously. The nurses literally have to wander through the infusion center or alternatively go down the hall to the individual patient's room in trying to locate the source of the audible alarm and determine if it is their patients and IV pump, which frequently it is not. Further this environment creates a significant source of interruption to the nurse's workflow, disrupts time spent with other patients, interferes with charting and documentation, and ultimately results in decreased productivity and an increased risk for error in not immediately tending to a particular patient's audible IV alarm. In the typical fast-paced, often hectic healthcare environment, patient care has become more complex, with higher nursing accuracy required combined with a higher volume of patients to tend to. Last decreasing the number of distractions to both nursing staff and patients is imperative to creating a more safe and healing environment in healthcare.

The IV Pump is the brains of the IV system via monitoring critical aspects of the IV fluid so that if any IV fluid parameter falls outside of a desired range during the outpatient treatment session the IV Pump will alarm locally at the IV Pump itself usually through an audible alarm and a visual indication through a display of the IV Pump. Thus this system of the single IV Pump local alarm is acceptable when a lone patient is in a hospital room or segregated area, wherein when the IV Pump alarms, it is fairly efficient for the nurse practitioner to quickly ascertain the nature of the IV Pump alarm and therefore take corrective action to correct the abnormal IV fluid parameter on a timely basis for that single IV patient. This results in the IV Pump alarm working successfully as a standalone device in its own room wherein the IV Pump alarm is easily discernible for the timely proper attention from the nurse practitioner as opposed to a large room containing a large number of IV Pumps close to one another that are alarming simultaneously wherein it is difficult for the nurse practitioner to distinguish as between the multiple IV Pump simultaneous alarms, thus making the timely corrective action performed upon a specific IV Pump more difficult for the nurse practitioner. Wherein drawing an analogy upon a car driver hearing multiple emergency vehicle sirens and having an aggravating difficulty in determining the positional orientation of the emergency vehicle siren.

Thus the focus of the present invention is upon a typical outpatient infusion center, wherein the patients are not in individual rooms and the outpatients are only at the hospital facility for their treatment or infusion session for a portion of a day, as typically an outpatient would be, however an inpatient situation could apply also to the present invention, wherein patients could be in an intensive care unit, or in rooms with two or more patients per room. Also, these infusion center outpatients are grouped together in close proximity to one another in a large room, also the outpatients are in a fixed seat position for the duration of their treatment, which means that there is a particular IV Pump and particular outpatient grouping together during the outpatient treatment session as previously defined. Further, with the nurse practitioner(s) being located in the same room and being assigned a number of outpatients. This would be opposed to a typical hospital situation wherein patients are in separate rooms being divided from their assigned nurses who are at a remote nurse's station usually on the same floor.

As the nurse practitioners are spread thin for their high assigned number of outpatients, it is important to quickly ascertain the nature of the IV Pump alarm and to correct the root cause of the alarm, both for the care of the outpatient and to stop the alarm as soon as possible for the peace (noise wise) and calm of all of the other outpatients and other attending nurse practitioners.

Looking at the prior art in U.S. Pat. No. 7,301,451 to Hastings, disclosed is a method for transferring data that can include receiving data from a monitoring device, then determining whether the subject or patient being monitored has a condition that may require attention, and sending a notification message to a portable electronic device that is designed to be carried by a caregiver if such a condition exists in the subject. In Hastings, the notification message may be sent using one or both of a first wireless data transfer method and a second wireless data transfer method, further the system may use both methods to communicate with one device or may use the first method to communicate with a first device and the second method to communicate with a second device.

The portable electronic device in Hastings may include two wireless transceivers such as a transceiver designed to connect the device to a local area network of a facility and a transceiver designed to connect the device to a cellular network. The focus of Hastings is to provide wireless signal backup by utilizing two signals to the portable device that gives a perceptible output to the medical caregiver of a particular patient's physiological attributes that can include text and/or data (i.e. ECG waveforms), thus this describes the receiving part of the Hastings system, however, there is no teaching as to signal generation at the monitoring device.

Further, in the prior art United States Patent Application Number 2012/0182924 to Gaines et al., disclosed is an architecture for networked communications between a series of medical devices and a remote monitoring device (via internet)-as in a patient at home being monitored at a central facility. In Gaines, an interface circuit is coupled to each medical device that communicates with one of a plurality of relay modules via a wireless relay network, wherein the relay modules communicate with the remote monitoring device over an internet-accessible wireless communication network. Each relay module in Gaines includes a receiver coupled to the wireless relay network, a first transmitter coupled to the wireless relay network, a second transmitter coupled to the internet-accessible wireless communications network; and a controller.

The controller in Gaines determines a status of the internet-accessible wireless communications network. In Gaines, when the status indicates that the internet-accessible wireless communications network is accessible to the wireless relay module, the second transmitter is selected for transmitting medical device data, further when the internet-accessible wireless communications network is not accessible; the first transmitter is selected for transmitting the data to another wireless relay module. Gaines uses a combination of internet and wireless data transfer; however, there is no teaching as to specifics of the signal generation or to the perceptible output (portable) of the signal reception.

Continuing in the prior art in U.S. Pat. No. 8,134,459 to Smith, et al. disclosed is a wireless network having an architecture that resembles a peer-to-peer network that has two types of nodes, a first sender type node and a second receiver/relay type node. The network in Smith may be used in a medical instrumentation environment whereby the first type node may be wireless devices that could monitor physical parameters of a patient such as for example wireless oximeters. The second type node in Smith is mobile wireless communicators that are adapted to receive the data from the wireless devices if they are within the transmission range of the wireless devices thus facilitating patient mobility within the hospital environment. Further in Smith, after an aggregation process involving the received data, each of the node communicators broadcasts or disseminates its most up to date data onto the network and any other relay communicator node in the network that is within the broadcast range of a broadcasting communicator node would receive the up to date data.

Thus Smith makes it possible for communicators that are out of the transmitting range of a wireless device to be appraised of the condition of the patient being monitored by the wireless device. Each communicator in the network in Smith is capable of receiving and displaying data from a plurality of wireless devices. There is mention in Smith of a sensor transmitter in U.S. Pat. No. 6,731,962, being a finger oximeter with remote telecommunication capability (single output and reception) wherein Smith adds tethering for a daisy chaining of the single signal to a number of perceptible output devices; however, there is no sophisticated software to control multiple data inputs for multiple patients.

Next, in the prior art U.S. Pat. No. 5,735,285 to Albert, et al., disclosed is a method and apparatus for transmission of biomedical waveform data from a patient to an attending physician wherein the waveform data audio signal is frequency modulated for subsequent wireline or wireless transmission to a remote hand-held computer that functions to digitize, record and demodulate the frequency modulated signal for display on the computer, for permanent print-out, or for further retransmission. The teaching in Albert is for the use of medical data transmission system via phone modem with audio transmission.

Continuing, in the prior art in U.S. Pat. No. 6,057,758 to Dempsey, et al., disclosed is a system for monitoring a physiological condition of a patient that includes a primary station and a portable station. The primary station in Dempsey includes a transmitter configured to transmit a signal, which represents a physiological condition of the patient, via a wireless communication link. In Dempsey, the portable station includes: a receiver configured to receive the signal, via the wireless communication link, from the primary station; a display configured to display, based upon the signal, a representation of the physiological condition to a user, and an alarm exhibitor configured to exhibit an alarm indication to the user in response to an identified anomaly in the physiological condition of the patient.

Further in Dempsey, the alarm exhibitor may be configured to exhibit the alarm indication in response to an alarm signal received, via the wireless communication link, from the primary station and the portable station may include a transmitter adapted to communicate, via the wireless communication link, with the primary station to permit the user to respond to the alarm indication. Dempsey has the ability to transmit “real time” dynamic waveform data from the patient with predefined responses from the health care provider, such as “validate”, “clear”, “talk”, and the like. However, Dempsey has no detailed teaching relating to the generation of the transmitted signal from patient monitoring.

What is needed is a system that is tailored specifically for outpatient infusion centers wherein a high number outpatients are one-on-one connected a high number of outpatient IV Pump alarms that are in close proximity to one another in a single open area room that are alarming simultaneously in the open room, wherein the system facilitates the nurse practitioner getting a wireless smart signal from each one of their assigned outpatients to a tablet personal computer (PC) that the nurse practitioner has on their person through a short range wireless signal. The smart signal will give a whole screen of status on the tablet PC of a particular outpatient and thus once the IV Pump alarm activates for a particular outpatient, the assigned nurse practitioner will instantly know which outpatient the alarm pertains to and what corrective action to take, with the nurse practitioner having the ability to clear certain selected IV Pump alarms from the tablet PC, thus resulting in the nurse practitioner more efficiently disposing of IV Pump alarms to reduce aggravation on both the part of the patients and the nurses. Typically the tablet PC through a vibrate and visual could give the alarm notification to the nurse first with a selected small time delay until the conventional audio and visual alarm is activated locally at the IV pump, thus resulting in minimizing the local audio and visual alarms at the IV pump that can aggravate the patient.

Wherein typically, multiple outpatients are receiving their treatment session in a large single open room, thus the present invention helps the nurse practitioner to more quickly single out and focus upon which particular outpatient is having an abnormal treatment session data indication in the open room. This is as opposed to the prior art system having a multitude of local (proximate to each outpatient) audio and visual alarms on the IV Pump-that requires the nurse practitioner to “hunt down” which outpatient's equipment is alarming, as typically each of the outpatient's are in close proximity to one another making it difficult for the nurse practitioner to quickly ascertain which particular outpatient needs their abnormal treatment session data corrected, in addition to each outpatient having to hear and see numerous audio and visual alarms of themselves and others that can lead to outpatient aggravation and unease.

To remotely monitor an outpatient's particular IV infusion treatment session data parameters, which could include for example the outpatient in an infusion center; wherein the infusion treatment session data parameters would include presence of gas in the infusion liquid that is flowing therethrough the IV tubing, pressure of the infusion liquid medication, flow-rate of the infusion liquid medication, time progress of the outpatient treatment session, and when the treatment session is complete. Further, logistical information related to the outpatient such as; outpatient name, outpatient seat number or location, assigned nurse practitioner, a bar code identification for the outpatient, the particular infusion liquid medication(s) used, the intravenous pump type identifier, and the ongoing status of the outpatient being OK or having a problem situation during the outpatient treatment session that the nurse practitioner needs to correct.

As previously mentioned in the outpatient infusion treatment center, there is usually a larger room wherein the outpatients are positioned in adjacent chairs to one another in rows with the outpatients being positioned in close proximity to one another. Each outpatient in the infusion center is adjacent to a suspended overhead infusion fluid reservoir suspended from an IV pole, wherein the reservoir is connected to an infusion fluid flexible flow tube essentially threading therethrough the IV Pump control apparatus in a peristaltic pump type manner, the IV Pump control apparatus measures infusion liquid parameters that include flow-rate, the infusion fluid gas or air content present in the tubing, the infusion liquid pressure. Plus the IV Pump control apparatus determines the total volumetric amount of the infusion medication that the particular outpatient should receive, with the IV Pump control apparatus shutting off the infusion liquid flow when that particular outpatient's infusion liquid medication volumetric amount has been fulfilled or a problem with the infusion liquid properties, i.e. flow rate, pressure, presence of gas, and the like. Further, the flexible tube continues from the IV Pump control apparatus and feeds into the particular outpatient's vein, wherein the flexible tube for sanitary purposes is a single length of tubing from the infusion liquid reservoir to the patient's vein, thus when the tubing passes therethrough the IV Pump control apparatus, the tubing is uninterrupted with all pumping and infusion liquid monitoring taking place outside of the tubing. Thus this entire infusion fluid feed and control system is termed an “IV” for intravenous and the infusion fluid is termed “IV liquid”.

### SUMMARY OF INVENTION

Broadly, the present invention is of the wireless remote notification system for use by a medical practitioner having a wireless capable tablet personal computer, for the medical practitioner to attend to each one of a positionally fixed group of multiple patients with each patient utilizing an uniquely identified intravenous fluid pump that monitors treatment session time, intravenous fluid gas content, intravenous fluid pressure, intravenous fluid flow-rate, and includes an alarm for one of the previously identified abnormal intravenous fluid conditions. The wireless remote notification system includes an individual patient dataset that has a plurality of patient parameters that include name, seat number, patient scan bar code, intravenous treatment fluid(s), treatment session time, volume of intravenous treatment fluid per treatment session, and the assigned medical practitioner.

Further included in the wireless remote notification system is a sensing control circuit configured to receive the individual patient dataset and link to the uniquely identified intravenous fluid pump which monitors the received treatment session time, also the intravenous fluid gas content, the intravenous fluid pressure, the intravenous fluid flow-rate, and to alarm for any of the previously identified abnormal intravenous fluid conditions. Also, the sensing circuit is configured to create a signal output for the individual patient dataset and link to the uniquely identified intravenous fluid pump, the received treatment session time, the intravenous fluid gas content, the intravenous fluid pressure, the intravenous fluid flow-rate, and alarm for any of the previously identified abnormal intravenous fluid conditions, the sensing control circuit is further configured to receive an alarm clearing signal and to deactivate the alarm.

In addition, included in the wireless remote notification system includes a wireless transceiver that is in electrical communication with the sensing control circuit, the wireless transceiver is configured to receive and wirelessly transmit in an output wireless signal the individual patient dataset and link to the uniquely identified intravenous fluid pump, the received treatment session time, the intravenous fluid gas content, the intravenous fluid pressure, the intravenous fluid flow-rate, and alarm for any of the previously identified abnormal intravenous fluid conditions, further the wireless transceiver is configured to receive a wireless alarm clearing signal and transmit the alarm clearing signal to the sensing control circuit and further to the intravenous fluid pump.

Further in the wireless remote notification system there are included one or more programs, wherein the one or more programs are stored in a memory of the tablet personal computer and executed by a one or more processors of the tablet personal computer, the one or more programs having instructions for producing a visual display on the tablet personal computer from the output wireless signal of the individual patient dataset and link to the uniquely identified intravenous fluid pump for a particular patient. The visual display including the received treatment session time, the intravenous fluid gas content, the intravenous fluid pressure, the intravenous fluid flow-rate, and alarm for any of the previously identified abnormal intravenous fluid conditions. Further, program instructions to facilitate the medical practitioner selectively inputting an alarm clearing command after correcting the alarmed abnormal intravenous fluid root condition in the patient, thus disposing of the alarm, resulting in the wireless alarm clearing signal generated from the tablet personal computer and received by the wireless transceiver and further communicated to the sensing control circuit and further to the intravenous fluid pump to minimize alarms at the intravenous fluid pump to minimize patient and nurse aggravation.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a simplified perspective view of a typical infusion center being situated in a large room with many patients who each are fixedly positioned in a recliner chair, each patient being adjacent to an IV pole, an IV reservoir or bag containing the IV infusion fluid or liquid, the tubing for the IV fluid, an IV Pump, audible and visual alarms for the IV pump, medical practitioners, the medical practitioners tablet PCs, and the partial height wall barrier;

FIG. 2 shows a diagrammatic schematic layout of the infusion center with the patients that each have audible and visual alarms for their IV Pump, and the medical practitioner that is in close proximity with the patient alarms overlapping one another making it difficult for the medical practitioner to individually discern a particular patient's alarm;

FIG. 3 shows a diagrammatic schematic layout of the present invention of the remote notification system integrated into the infusion center as depicted in FIGS. 1 and 2, wherein the IV Pump local audio and visual alarms remain as in the prior art, however, with the present invention additions of an output wireless signal from the sensing control circuit on the IV Pump to the tablet PC and a return wireless signal termed an alarm clearing signal from the tablet PC to the sensing control circuit and further to the IV Pump alarm, also shown is patient data logging and network backup for patient data;

FIG. 4 is a diagrammatic flow chart showing the process that the medical or nurse practitioner goes through in utilizing the present invention of the wireless remote notification system, wherein firstly the nurse practitioner is authenticated on the tablet PC as in a conventional login, next the nurse practitioner gains access to their assigned patient group with a summary display of the patient group, wherein each patient's alarm status for an abnormal IV fluid condition is displayed in the summary display, if the patient alarm indicates YES for a problem, then the nurse practitioner touches the particular alarmed patient identification on the summary display which leads to a detailed display for the particular alarmed patient, wherein the nurse practitioner will have detailed information of the exact nature of that particular patient's alarmed abnormal IV fluid condition, wherein the nurse practitioner takes corrective action to clear the root of the alarm condition for the associated patient, at which point the nurse practitioner clears the alarm on the tablet PC which in turn will deactivate the alarm on the IV pump sooner than the prior art would allow, or possibly prevent the alarm on the IV pump from activating in the first place, with a small time delay as between the tablet PC being alarmed first and the IV pump being alarmed second, all towards reducing the patient's anxiety level, in the case of the patients not having alarms, then the nurse practitioner would log out at the end of their shift;

FIG. 5 is a screen shot view of the summary display for the tablet PC of the nurse practitioners assigned patient group wherein the summary display gives a snapshot look at each one of the patient's basic information that includes patient name, patient seat number, the assigned nurse practitioner, and a summary alarm status for that patient;

FIG. 6 shows a screen shot view of the detailed display for the tablet PC of a single patient being derived from the FIG. 5 summary display, wherein the exact nature of the alarmed abnormal intravenous fluid condition of the patient is shown, in addition to being displayed the patient name, the patient seat number, the intravenous fluid used for this particular patient and which intravenous fluid has the problem alarm, treatment session time progress, IV fluid gas content, initial/elapsed time for IV fluid gas content, IV fluid pressure, initial/elapsed time for IV fluid pressure, IV fluid flow rate, initial/elapsed time for IV fluid flow rate, IV fluid alarm for an abnormal IV fluid condition, patient treatment session time complete-all IV fluid dispensed to patient, two minute warning prior to patient treatment session time complete-all IV fluid dispensed to patient, identifier for IV pump, patient bar code, and the alarm clearing command;

FIG. 7 shows a diagrammatic schematic of the wireless remote notification system with the data flow shown, starting with the IV pump and its two alarms being audible and visual being in conjunction with an individual patient dataset that is used by the sensing control circuit to output through the wireless transceiver to the wireless tablet personal computer that can receive the output wireless signal and has application programs to generate displays, further shown is the alarm clearing command that sends the alarm clearing signal back to the IV pump, in addition to the patient data logging, and the patient data backup on the network;

FIG. 8 shows a retrofit option for the wireless remote notification system that utilizes a camera to capture images of the IV fluid pump display and transmit the IV fluid pump display wirelessly to the wireless capable tablet computer, wherein optical character recognition technology converts the IV fluid pump display image into a data signal that manipulates the data into selected displays on the wireless capable tablet computer, enabling the use of currently existing IV fluid pumps that do not have wireless data transmission capabilities for the data displayed on the local IV fluid pump display screen;

FIG. 9 shows a diagrammatic schematic of the wireless remote notification system of FIG. 8 with the data flow shown, starting with the IV pump and its two alarms being audible and visual being in conjunction with the camera that outputs an individual patient dataset from the IV fluid pump display screen to output through the wireless transmitter to the tablet PC that can receive the output wireless signal and has application programs that utilize Optical Character Recognition from the camera wireless screen display image to generate displays in the wireless capable tablet personal computer, in addition to the patient data logging, and the patient data backup on the network;

FIG. 10 shows a diagrammatic schematic of the wireless remote notification system of FIG. 8 with the data flow shown, starting with the IV pump and its two alarms being audible and visual being in conjunction with the camera that integrates and has application programs that utilize Optical Character Recognition from the camera wireless screen display image to generate the wireless signal that outputs an individual patient dataset from the IV fluid pump display screen to the wireless tablet personal computer that can receive the output wireless signal to generate displays in the wireless capable tablet personal computer, in addition to the patient data logging, and the patient data backup on the network;

FIG. 11 is the first Figure in a summary flow chart group that includes FIGS. 11, 12, and 13, that starts in the upper left had corner of FIG. 11 with the patient who is attached to the IV pump or any other machine that could include in the medial field a Tube Feeding Pump, a Ventilator, a Cardiac Monitor, a Cooling Machine, a Bispectral Index (BIS) Monitor, an Anesthesia Monitor, a Seizure Monitor, or any other like machine, wherein the machine is initiated to operate, next, the present invention of the Remote Notification System reads the video feed from the output screen of the machine, links the machine output to a particular patient and wireless sly in an encrypted manner sends the output to the tablet/phone display for viewing by the medical practitioner, and can also display other supporting account information related to the patient and/or the machine, and then the chart flow continues through 500 to FIG. 12;

FIG. 12 picks up the chart flow at 500 to continue to read the machine display that if the machine/patient task is complete, the chart flow goes to 503 to continue to FIG. 13, otherwise if the machine patient task is not complete then the feed frames (images) are sent to OCR for interpretation and generation of textual content wherein it is determined in the tablet/phone app if an alert is needed or not that continues to chart flow 501 that continues in FIG. 13;

FIG. 13 shows the chart flow continuation 503 from FIG. 12 that ends the process, also chart flow continuation 501 from FIG. 12 on the alert or no alert, and if no alert then the chart flow continuation 502 back to FIG. 12 goes to iterate the machine video read process, if there is a patient alert, then appropriate action is taken by the medical practitioner, after which the system is reset and returns to chart flow 502 in going from FIG. 13 to FIG. 12 to continue to read the machine display;

FIG. 14 is the first Figure in a summary flow chart group that includes FIGS. 14 and 15, that starts in the upper left had corner of FIG. 14 with the patient who is attached to the IV pump or any other machine that could include in the medial field a Tube Feeding Pump, a Ventilator, a Cardiac Monitor, a Cooling Machine, a Bispectral Index (BIS) Monitor, an Anesthesia Monitor, a Seizure Monitor, or any other like machine, wherein the machine is initiated to operate, next the present invention of the Remote Notification System reads the video via a camera with integral OCR or data feed from the output screen of the machine or data from internally in the machine, links the machine output to a particular patient and wirelessly in an encrypted manner sends the output via chart flow 505 to FIG. 15;

FIG. 15 starts at chart flow 505 for the generation of textual content from the OCR wherein it is determined in the tablet/phone app if an alert is needed or not, that continues to the tablet/phone display for viewing by the medical practitioner, and if an alert is needed an alarm can be activated to inform the medial practitioner to take action as appropriate, wherein the medical practitioner can reset the app in the tablet/phone display, at which point the textual content is continued to be read for an alert or no alert in the tablet/phone app;

FIG. 16 shows a summary diagrammatic schematic layout of the present invention of the remote notification system using any type of general machine with the present invention having an output wireless signal from the machine using either a camera with OCR to read a machine perceptible output screen with the sensing control circuit or directly from the machine itself to send the wireless signal including the machine perceptible output to the tablet/phone, also shown is machine data logging and network backup for machine data based upon the machine perceptible output;

FIG. 17 is a diagrammatic flow chart showing the process that the user goes through in utilizing the present invention of the wireless remote notification system, wherein firstly the user is authenticated on the tablet or phone as in a conventional login, next the user gains access to their assigned machine with a summary display of the machine group, wherein each machine's alarm status for an abnormal perceptible output given the operable ranges of each of the machine perceptible outputs is displayed in the summary display, if the machine alarm indicates YES for a problem, then the user touches the particular alarmed machine identification on the summary display which leads to a detailed display for the particular alarmed machine, wherein the user will have detailed information of the exact nature of that particular machine's alarmed condition, wherein the user takes corrective action to clear the root of the alarm condition for the associated machine, at which point the user clears the alarm on the tablet or phone display, in the case of the machines not having alarms, then the user would log out at the end of their shift;

FIG. 18 is a screen shot view of the summary display for the tablet or phone display of the user's assigned machine group wherein the summary display gives a snapshot look at each one of the machine's basic information that includes machine name, machine location, the assigned user, and a summary alarm status for that machine;

FIG. 19 shows a diagrammatic schematic of the wireless remote notification system with the data flow shown, starting with the machine outputting perceptible outputs being in conjunction with an individual machine dataset that is used by the sensing control circuit to output through the wireless transceiver to the wireless tablet or phone that can receive the output wireless signal and the tablet or phone having application programs or app(s) to generate screen displays, further shown is the alarm clearing command that resets the display from the alarm condition to the prior machine perceptible outputs being displayed with acceptable perceptible output operating ranges, in addition to the machine data logging, and the machine data backup on the network, with machine data being defined as perceptible outputs being displayed with acceptable perceptible output operating ranges for each perceptible output;

FIG. 20 shows a diagrammatic schematic of the wireless remote notification system starting with the machine having a display outputting perceptible outputs being in conjunction with the camera that outputs an individual machine dataset from the machine display screen to output through the wireless transmitter to the tablet or phone that can receive the output wireless signal and has application programs that utilize Optical Character Recognition (OCR) from the camera wireless screen display image to generate displays in the wireless capable tablet or phone, in addition to the machine data logging, and the machine data backup on the network; and

FIG. 21 shows a diagrammatic schematic of the wireless remote notification system, starting with the machine having a display outputting perceptible outputs being in conjunction with the camera that integrates and has application programs that utilize Optical Character Recognition (OCR) from the camera wireless screen display image to generate the wireless signal that outputs an individual machine dataset from the machine display screen to the wireless tablet or phone that can receive the output wireless signal to generate displays in the wireless capable tablet personal or phone, in addition to the machine data logging, and the machine data backup on the network.

### REFERENCE NUMBERS IN DRAWINGS

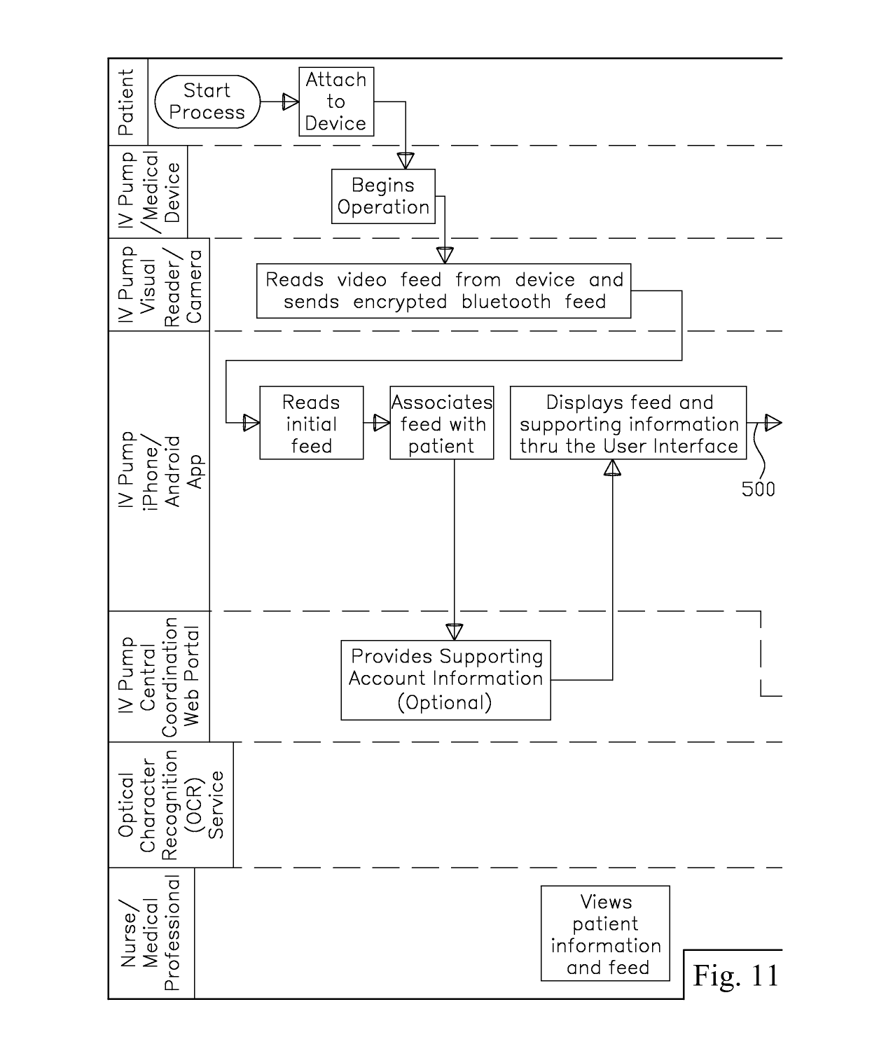

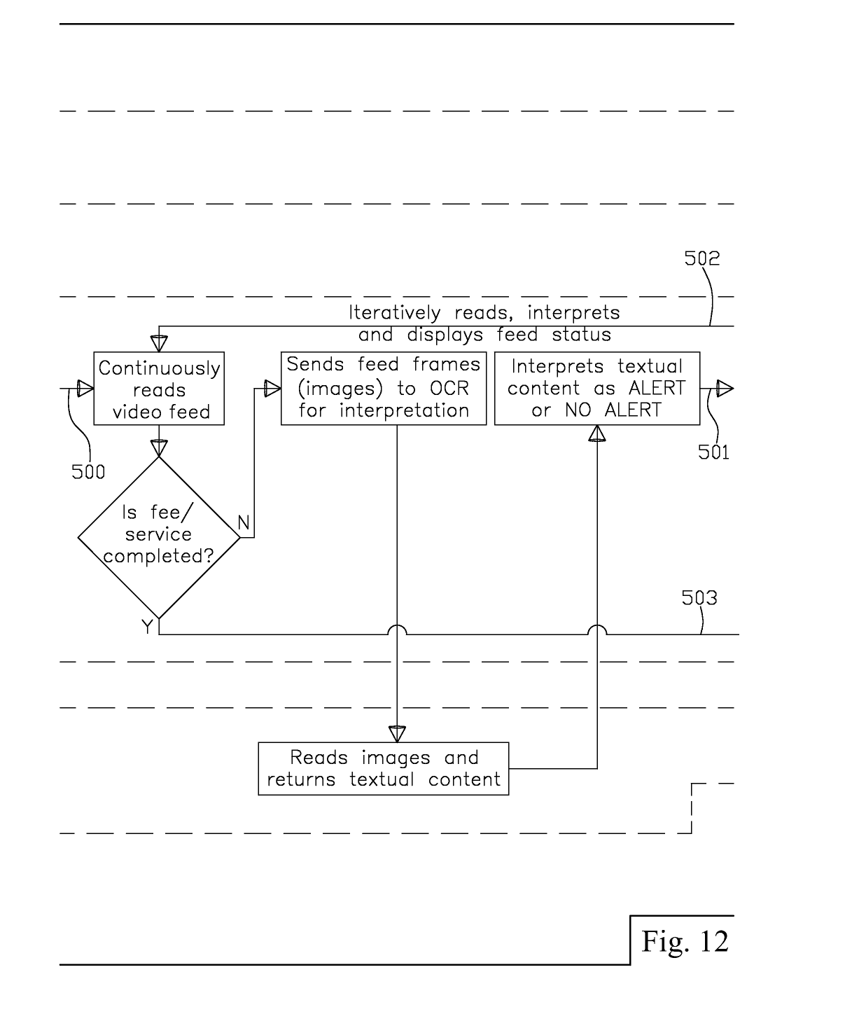

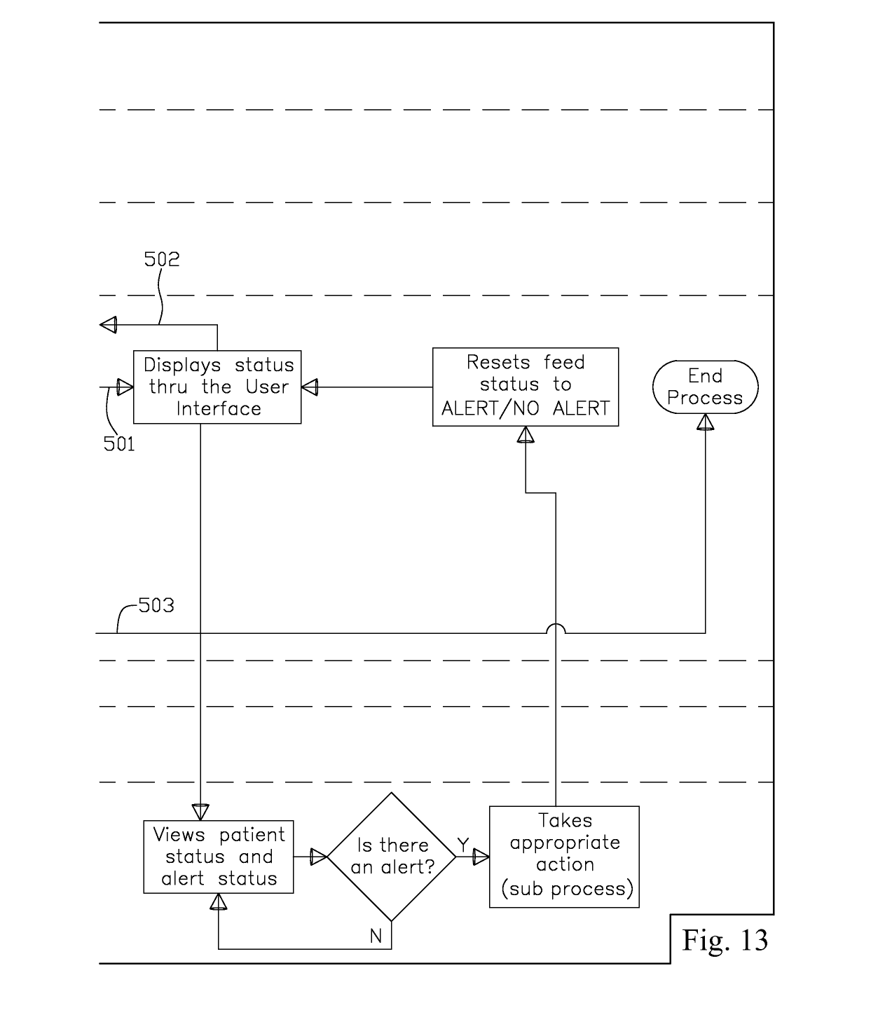

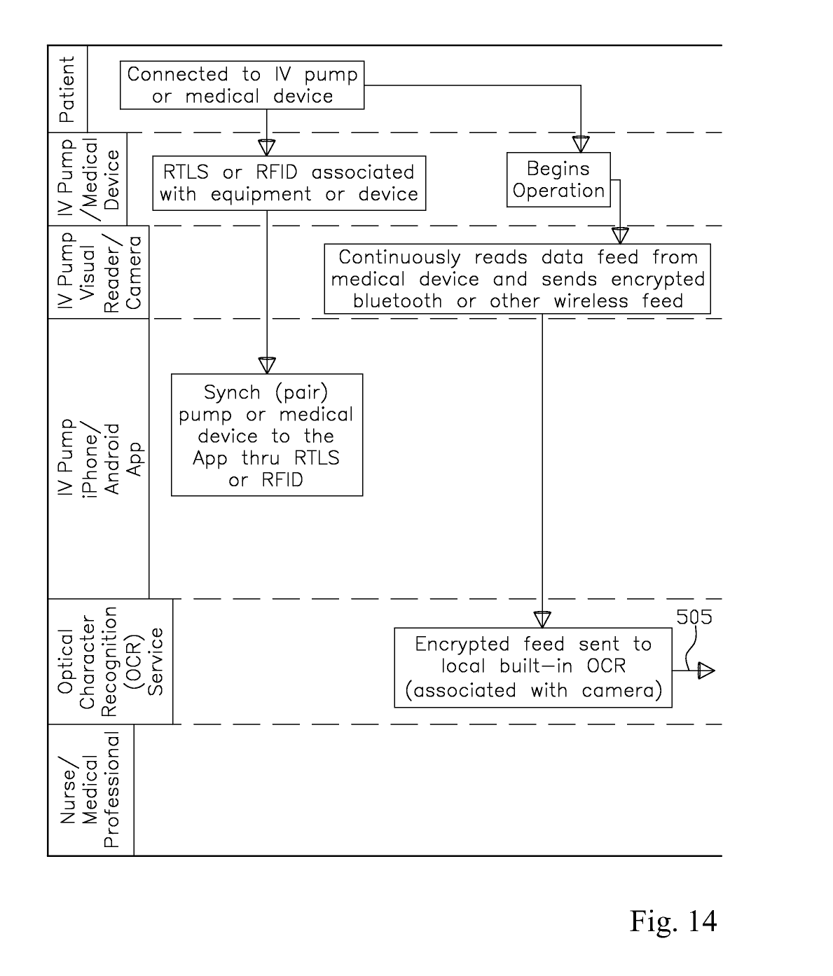

50 Wireless remote notification system
51 Wireless remote notification system with camera 57
55 Intravenous (IV) fluid pump or machine having a perceptible output
56 Display for IV fluid pump 55 or machine 55
57 Camera for display
58 Wireless signal for image from camera 57
59 Optical Character Recognition (OCR) for converting camera display image wireless signal 58 from display 56 into a data signal, wherein the OCR can either be remote (in a separate program 150 or in the cloud (internet accessible)) or integral with the camera 57
60 Local IV fluid pump 55 audible alarm
65 Local IV fluid pump 55 visual alarm
70 Reservoir for IV fluid 71
71 IV fluid
75 Pole for IV reservoir 70
80 Tubing for IV fluid 71
85 Wireless capable tablet personal computer or phone
90 Medical practitioner or user
95 Infusion center
100 Patient(s)
105 Individual patient 100 dataset
106 Individual machine 55 dataset
110 Patient 100 recline chair
115 Partial wall barrier
120 Sensing control circuit
125 Wireless alarm clearing signal
130 Alarm 185 clearing signal
135 Deactivate alarm 185 by the medical practitioner 90 or user
140 Wireless transceiver
141 Wireless transmitter
145 Output wireless signal
150 Programs
155 Memory
160 Processors
165 Visual display of the tablet personal computer 85 or phone
170 Summary display of medical practitioner 90 assigned patients 100 or user for assigned machine 55
175 Patient name or machine name 55 in display 170
180 Patient seat number in display 170 or machine 55 location
185 Alarm or alert activation status for abnormal intravenous fluid 71 or machine 55 condition on the patient 100 or machine 55
190 Assigned nurse practitioner to patient 100 or user to machine 55
200 Detail display of each medical practitioner 90 assigned patient 100
205 Patient IV fluids
210 Treatment session time progress
211 Volume of IV fluid to be dispensed
215 IV fluid 71 gas content
220 Initial/elapsed time for IV fluid 71 gas content 215
225 IV fluid 71 pressure
230 Initial/elapsed time for IV fluid 71 pressure 225
235 IV fluid 71 flow rate
240 Initial/elapsed time for IV fluid 71 flow rate 235
245 IV fluid 71 alarm for an abnormal IV fluid 71 condition or machine 55 perceptible output outside of acceptable operating ranges
250 Patient 100 treatment session time to complete-all IV fluid 71 dispensed to patient 100
255 Two minute warning prior to patient 100 treatment session time complete-all IV fluid 71 dispensed to patient 100
260 Identifier for IV pump 55
265 Patient 100 bar code
270 Alarm clearing command
275 Data logging for patient 100 or machine 55
280 Network backup for patient 100 data or machine 55 perceptible output
285 Authenticate the medical practitioner 90 or user for the visual display 165
290 Medical practitioner 90 or user gaining access to the tablet 85 display 165
295 Medical practitioner 90 or user reviewing summary display 170 status of each assigned patient 100 or machine 55 being either OK or YES to problem causing alarm 185 or alert for the abnormal intravenous fluid 71 condition or out of acceptable perceptible output operational range for the machine 55 perceptible outputs
300 Medical practitioner 90 or user reviews problem notification on patient 100 or machine 55 on summary display 170
305 Medical practitioner 90 or user goes to patient 100 or machine 55 detail display 200
310 Medical practitioner 90 or user takes corrective action the alarmed 185 abnormal intravenous fluid 71 condition or machine 55 operating outside of acceptable perceptible output operational ranges in the patient 100 or machine 55 thus disposing 135, 270 of the alarm 185
315 Medical practitioner 90 or user clearing 270 patient 100 or machine 55 alarm 185
320 Logout of medical practitioner 90 or user
500 Continuation from FIG. 11 to FIG. 12
501 Continuation from FIG. 12 to FIG. 13
502 Continuation from FIG. 13 to FIG. 12
503 Continuation from FIG. 12 to FIG. 13
505 Continuation from FIG. 13 to FIG. 14

### DETAILED DESCRIPTION

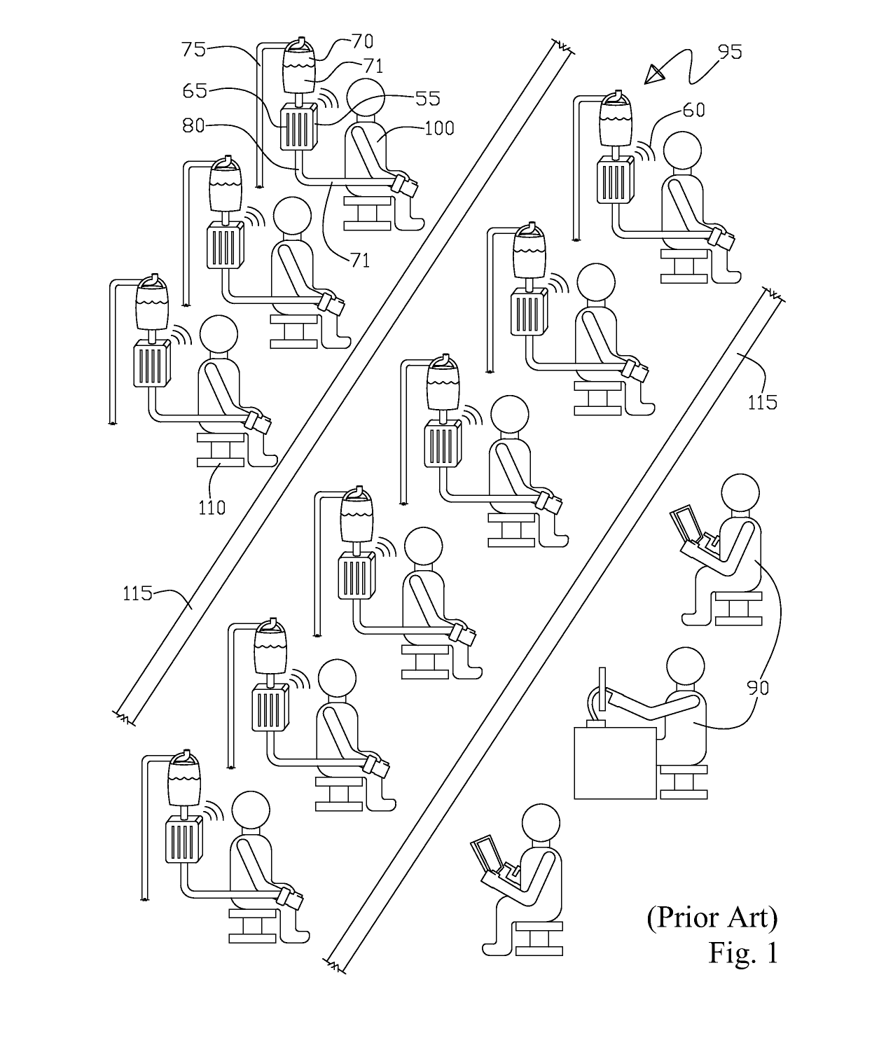

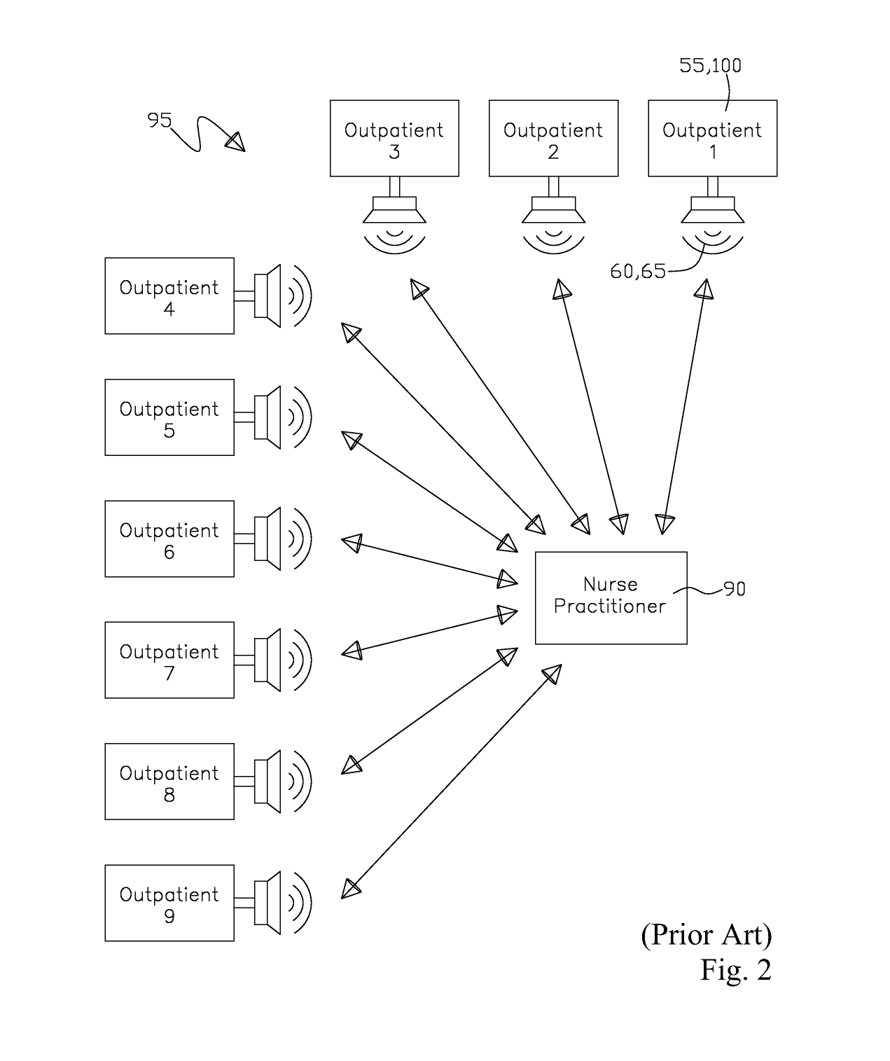

Starting with FIG. 1, shows a simplified perspective view of a typical infusion center 95 being situated in a large room with many patients 100 who each are fixedly positioned in a recliner chair 110 with each being adjacent to an IV pole 75, an IV reservoir 70 or bag containing the IV infusion fluid 71 or liquid, the tubing 80 for the IV fluid 71, an IV Pump 55, audible 60 and visual 65 alarms for the IV Pump 55, medical practitioners 90, the medical practitioners 90 tablet PCs 85, and the partial height wall barrier 115. Continuing, FIG. 2 shows a diagrammatic schematic layout of the infusion center 95 with the patients 100 that each have audible 60 and visual 65 alarms for their IV pump 55, and the medical practitioner 90 that is in close proximity with the patient alarms 60, 65, overlapping one another making it difficult for the medical practitioner 100 to individually discern a particular patient's alarm 185 root cause.

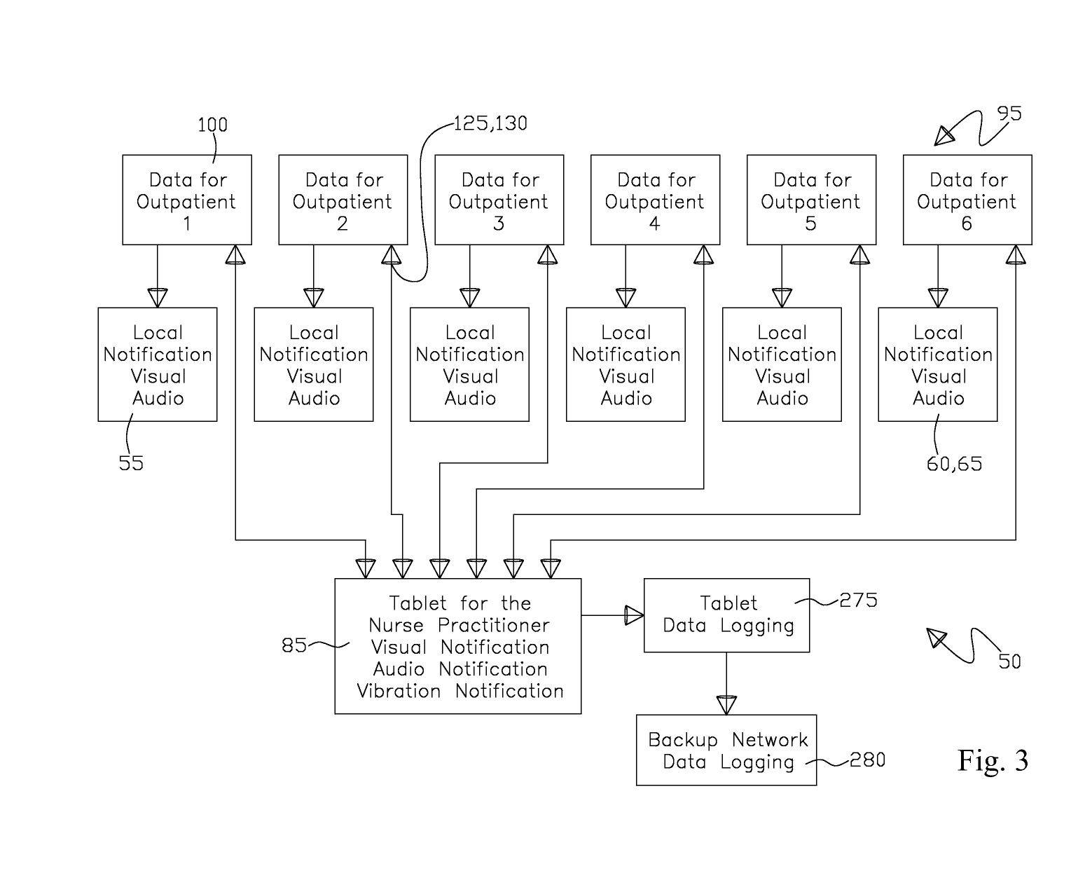

Further, FIG. 3 shows a diagrammatic schematic layout of the present invention of the remote notification system 50 integrated into the infusion center 95 as depicted in FIGS. 1 and 2, wherein the IV pump 55 local audio 60 and visual 65 alarms remain as in the prior art, however, with the present invention 50 additions of a output wireless signal 145 from the sensing control circuit 120 on the IV pump 55 to the tablet PC 85, and a return wireless signal 125 termed an alarm clearing signal from the tablet PC 85 to the sensing control circuit 120, and further to the IV pump 55 alarm 60, 65, also shown is patient 100 data logging 275, and network backup 280 for patient 100 data.

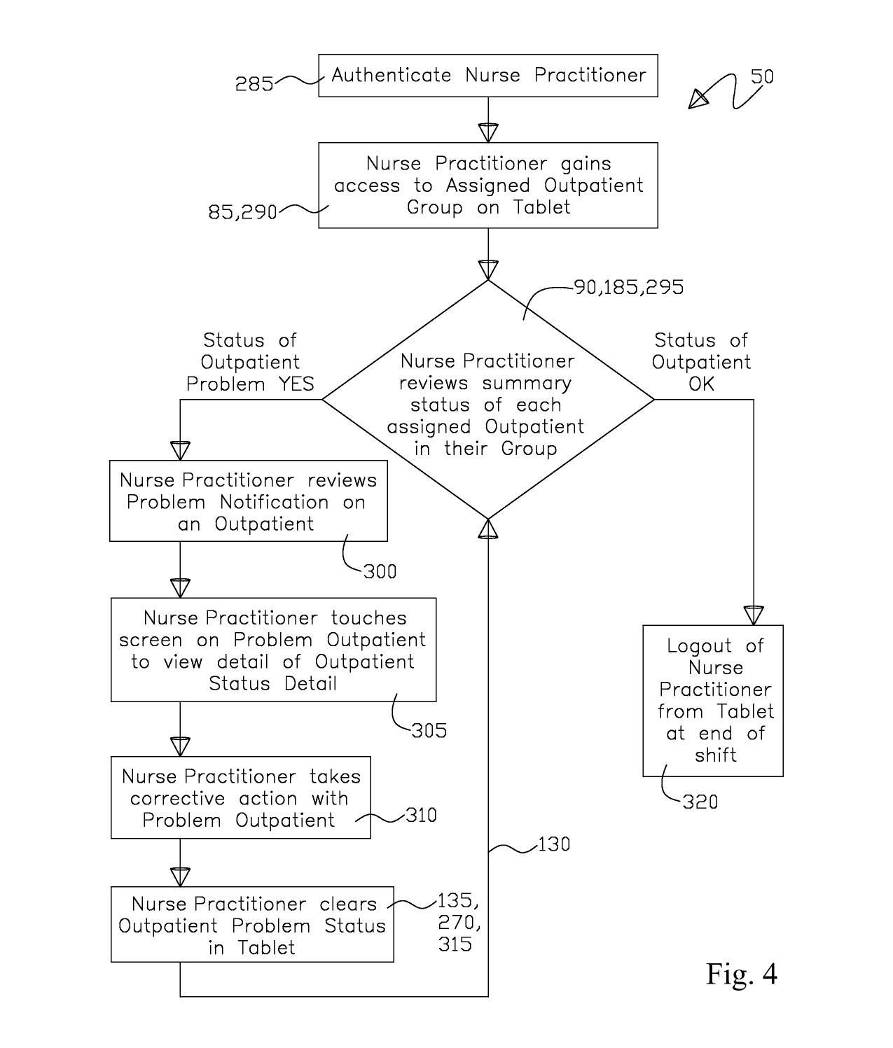

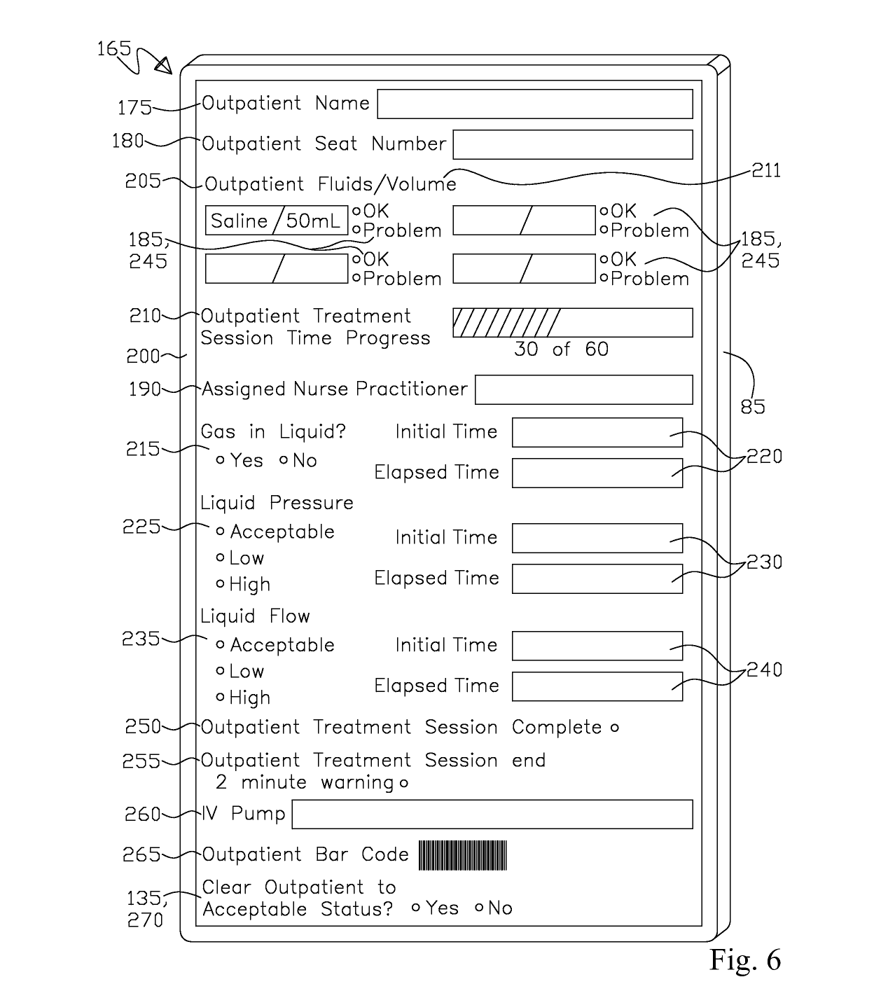

Next, FIG. 4 is a diagrammatic flow chart showing the process that the medical or nurse practitioner 90 goes through in utilizing the present invention of the wireless remote notification system 50, wherein firstly the nurse practitioner 90 is authenticated 285 for the tablet PC 85 as in a conventional login. Continuing, in FIG. 4 the nurse practitioner 90 gains access 290 to their assigned 190 patient 100 group with a summary display 170 of the patient 100 group, wherein each patient's 100 alarm status 185 for an abnormal IV fluid 71 condition is displayed for review 295 by the nurse practitioner 90 in the summary display 170. Also shown in FIG. 4, during the nurse practitioner 90 review 300, if the patient 100 alarm 185 indicates YES for a problem, then the nurse practitioner 90 touches and then goes to 305 the particular alarmed patient 100 identification on the summary display 170 which leads to a detailed display 200 for that particular alarmed patient 100, see FIG. 6, wherein the nurse practitioner 90 will have detailed information of the exact nature of that particular patient's 100 alarmed 185 abnormal IV fluid 71 condition.

Wherein at this point in FIG. 4, the nurse practitioner 90 takes corrective action 310 to clear the alarm 185 root condition for the associated patient 100, at which point the nurse practitioner 90 clears 315 the alarm 270 on the tablet PC which in turn will deactivate 135 the alarm on the IV pump 55 sooner than the prior art would allow or possibly prevent the alarm 270 on the IV pump 55 from activating in the first place with a small time delay as between the tablet PC 85 being alarmed first and the IV pump 55 being alarmed second, all towards reducing the patient's 100 anxiety level. Also, in FIG. 4, in the case of the patients 100 not having alarms 270, then the nurse practitioner 90 would log out 320 at the end of their shift.

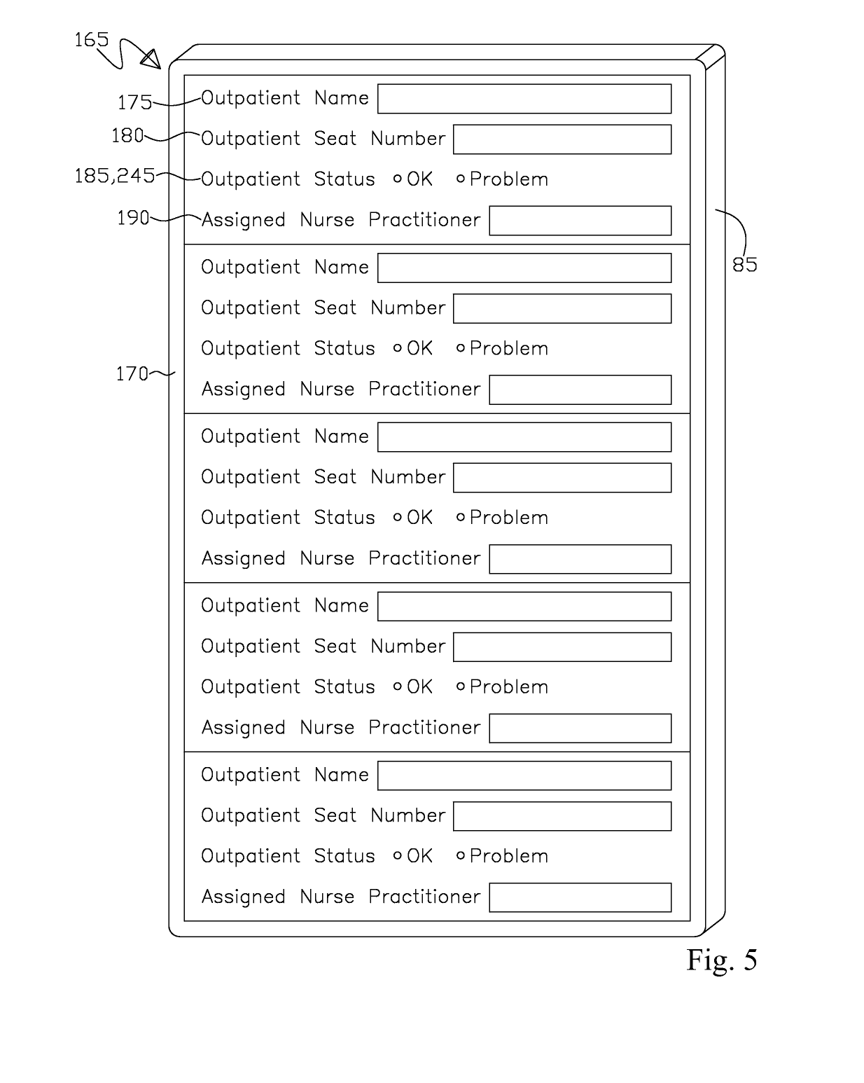

Moving on toward FIG. 5 shown is a screen shot view of the summary display 170 for the tablet PC 85 of the nurse practitioners 90 assigned 190 patient 100 group, wherein the summary display 170 gives a snapshot look at each one of the patient's 100 basic information that includes patient name 175, patient seat number 180, the assigned 190 nurse practitioner 90, and a summary alarm status 185 for that patient 100.

Further, FIG. 6 shows a screen shot view of the detailed display 200 for the tablet PC 85 of a single patient 100 being derived from the FIG. 5 summary display 170, wherein the exact nature of the alarmed 185 abnormal intravenous fluid 71 condition of the patient 100 is shown. Further FIG. 6 shows in addition, to being displayed the patient name 175, the patient seat number 180, the intravenous fluid(s) 205 used for this particular patient 100 and which particular intravenous fluid 71 has the problem alarm 185. FIG. 6 also shows the treatment session time progress 210, IV fluid 71 gas content 215, initial/elapsed time for IV fluid 71 gas content 220, IV fluid 71 pressure 225, initial/elapsed time 230 for IV fluid 71 pressure 225. Further FIG. 6 shows IV fluid 71 flow rate 235, initial/elapsed time 240 for IV fluid 71 flow rate 235, IV fluid 71 alarm 245 for an abnormal IV fluid 71 condition, patient 100 treatment session time complete 250-meaning all IV fluid 71 is dispensed to the patient 100, two minute warning 255 prior to patient 100 treatment session time complete 250, meaning again-all IV fluid 71 is dispensed to the patient 100, an identifier 260 for the IV pump 55, the patient bar code 265, and the alarm clearing 270 command.

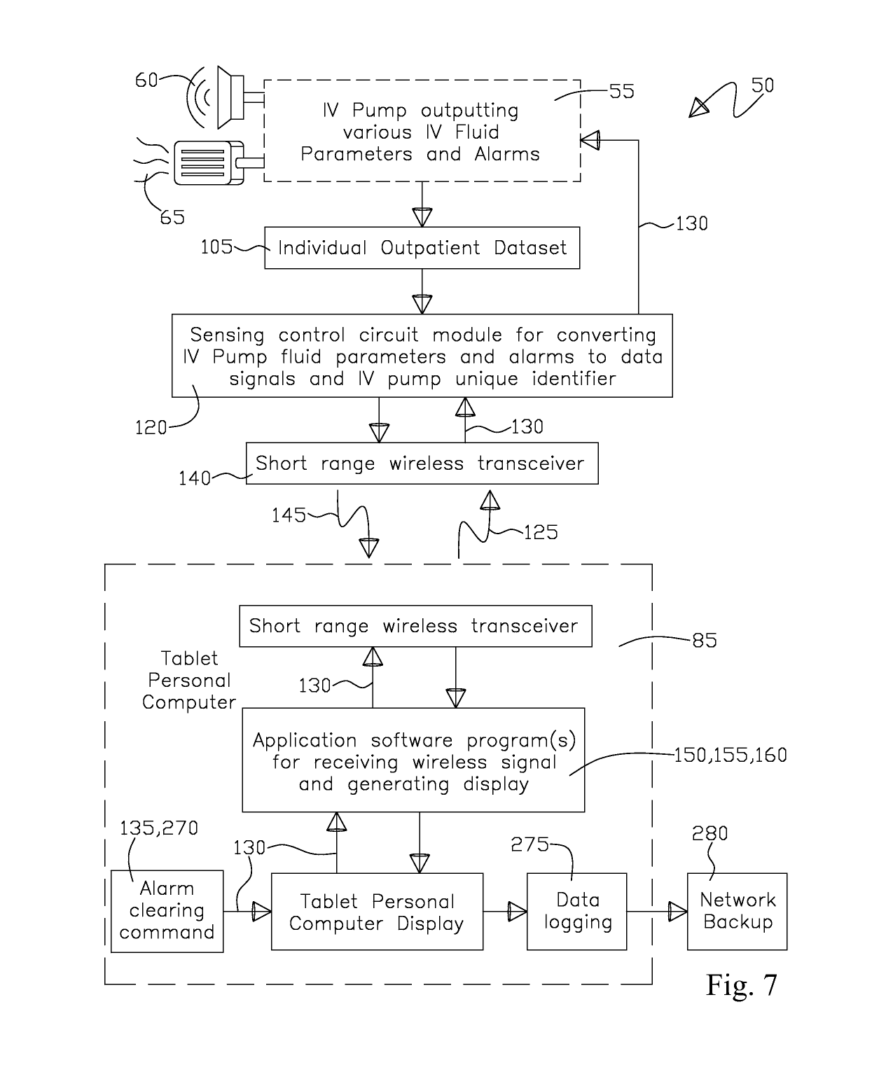

Next, FIG. 7 shows a diagrammatic schematic of the wireless remote notification system 50 with the data flow shown, starting with the IV Pump 55 and its two alarms being audible 60 and visual 65, being in conjunction with an individual patient dataset 105 that is used by the sensing control circuit 120 to output through the wireless transceiver 140 to the wireless tablet personal 85, that can receive the output wireless signal 145 and has application programs 150 to generate displays 165. Further shown in FIG. 7 is the alarm clearing command 135, 270, that sends the alarm clearing signal 130 back to the IV Pump 55, in addition to the patient 100 data logging 275, and the patient 100 data backup 280 on the network.

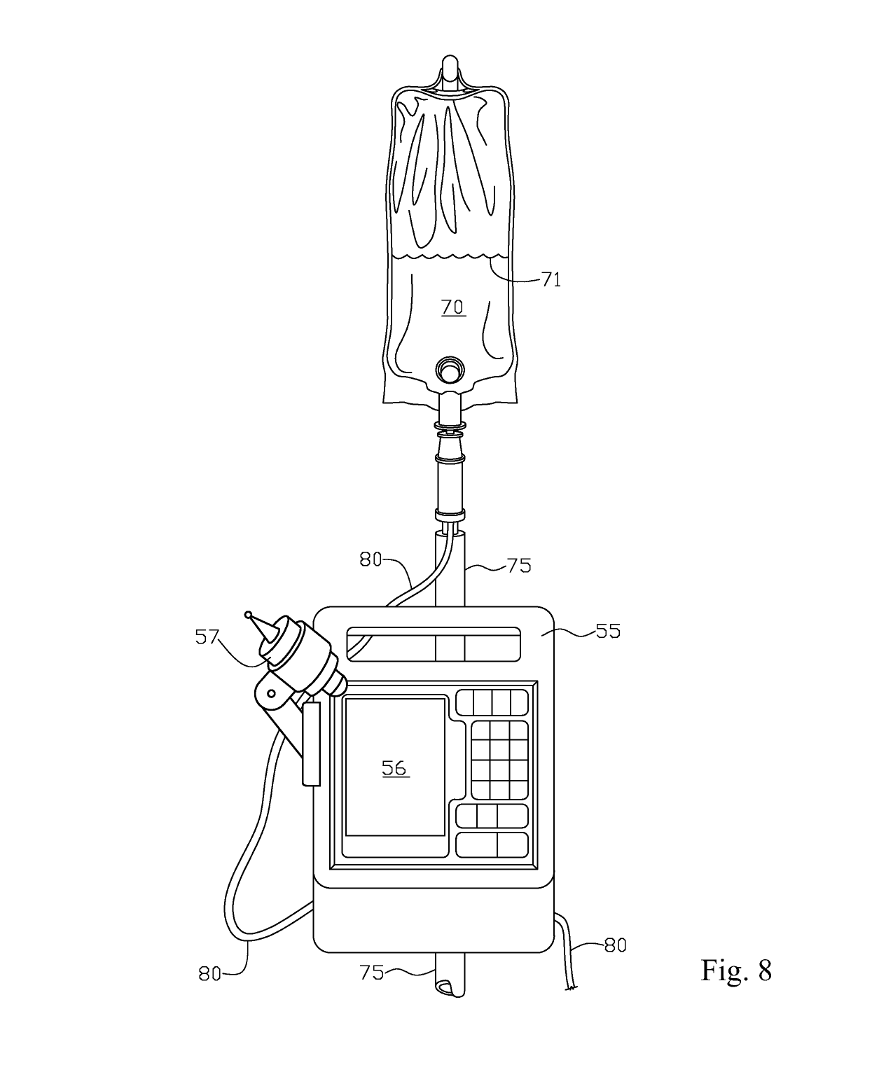

Further, FIG. 8 shows a retrofit option for the wireless remote notification system 51 that utilizes a camera 57 to capture images of the IV fluid pump 55 display 56 and transmit the IV fluid pump display wireless sly 58 to the wireless capable tablet computer 85, wherein optical character recognition technology 59 converts the IV fluid pump 55 local display image 56 into a data signal 58 that manipulates the data into selected displays 170, 200 on the wireless capable tablet computer 85, enabling the use of currently existing IV fluid pumps 55 that do not have wireless data transmission capabilities for the data displayed on the local IV fluid pump 55 display screen 56.

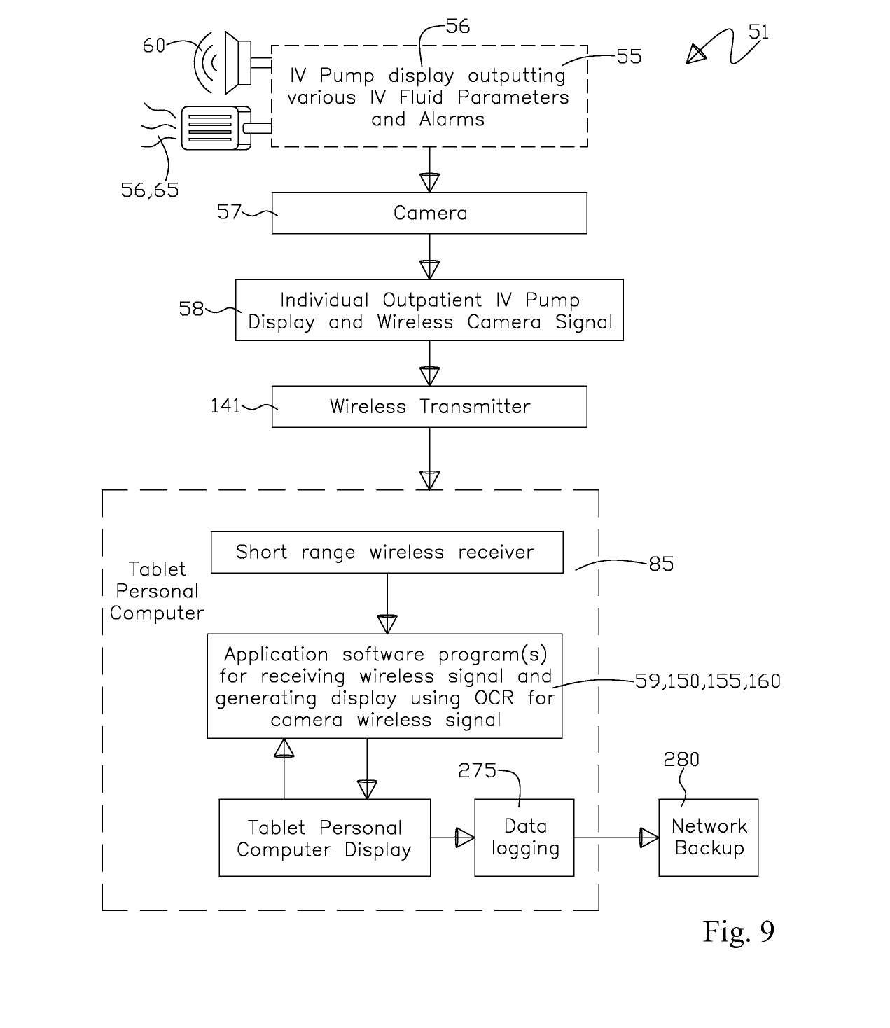

Next, FIG. 9 shows a diagrammatic schematic of the wireless remote notification system 51 of FIG. 8 with the data flow shown, starting with the IV pump 55 and its two alarms being audible 60 and visual 65 being in conjunction with the camera 57 that outputs an individual patient dataset 58 from the IV fluid pump 55 display screen 56 to output through the wireless transmitter 141 to the tablet PC 85 that can receive the output wireless signal 58. Also, FIG. 9 denotes application programs that utilize Optical Character Recognition 59 from the camera 57 wireless screen display image 56 to generate displays 170, 200, in the wireless capable tablet personal computer 85, in addition to the patient data logging 275, and the patient data backup 280 on the network.

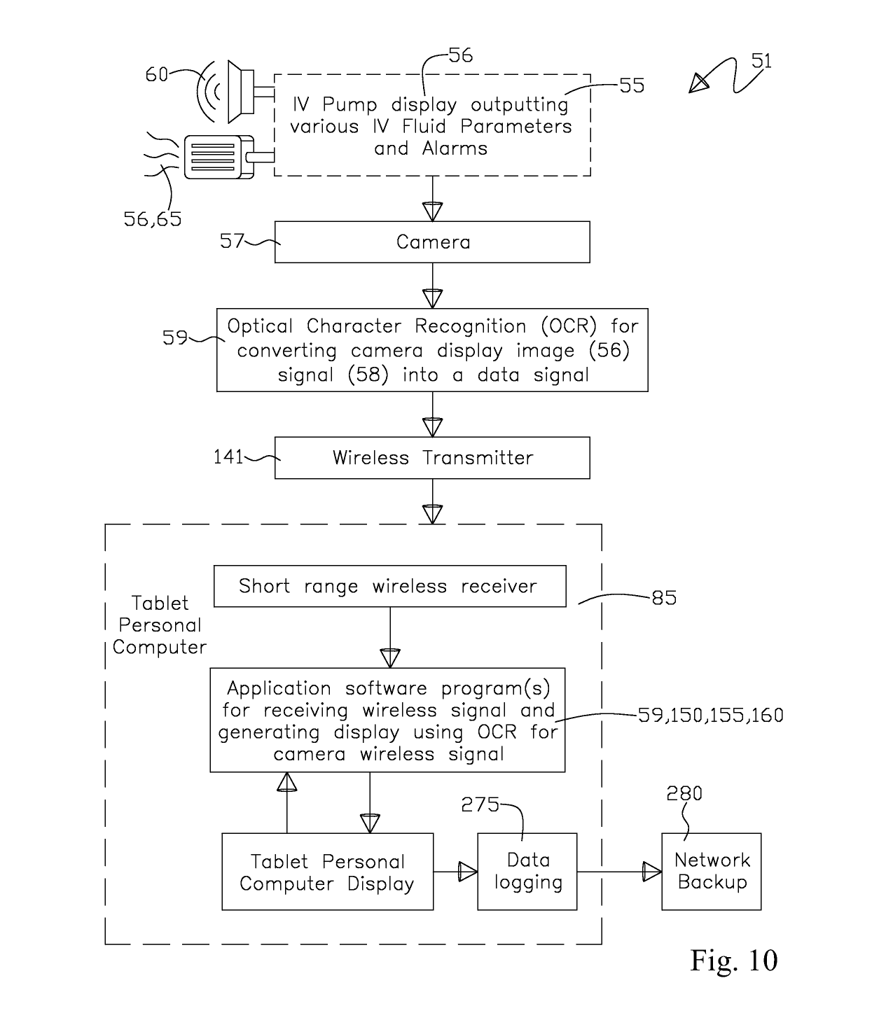

Further, FIG. 10 shows a diagrammatic schematic of the wireless remote notification system 51 of FIG. 8 with the data flow shown, starting with the IV pump 55 and its two alarms being audible 60 and visual 65 being in conjunction with the camera 57 that integrates and has application programs that utilize Optical Character Recognition 59 from the camera 57 wireless screen display image 56. Further, FIG. 10 shows that the camera 57 is to generate the wireless signal 58 that outputs an individual patient dataset from the IV fluid pump 55 display screen 56 to the wireless tablet personal computer 85 that can receive the output wireless signal 145 to generate displays 170, 200, in the wireless capable tablet personal computer 85, in addition to the patient data logging 275, and the patient data backup 280 on the network.

Continuing, FIG. 11 is the first Figure in a summary flow chart group that includes FIGS. 11, 12, and 13, that starts in the upper left had corner of FIG. 11 with the patient 100 who is attached to the IV pump 55 or any other machine that could include in the medial field a Tube Feeding Pump, a Ventilator, a Cardiac Monitor, a Cooling Machine, a Bispectral Index (BIS) Monitor, an Anesthesia Monitor, a Seizure Monitor, or any other like machine 55. Wherein the machine 55 in FIG. 11 is initiated to operate, next the present invention of the Remote Notification System 50 reads the video feed from the output screen of the machine 55, links the machine 55 output to a particular patient 100 and wirelessly in an encrypted manner sends the output to the tablet/phone 85 display for viewing by the medical practitioner 90, and can also display other supporting account information related to the patient 100 and/or the machine 55, and then the chart flow continues through 500 to FIG. 12.

Moving onward, FIG. 12 picks up the chart flow at 500 to continue to read the machine 55 display that if the machine 55/patient 100 task is complete the chart flow goes to 503 to continue to FIG. 13. Otherwise in FIG. 12, if the machine 55 patient 100 task is not complete then the feed frames (images) are sent to OCR for interpretation and generation of textual content wherein it is determined in the tablet/phone 5 app 150 if an alert 185 is needed or not that continues to chart flow 501 that continues in FIG. 13.

Continuing, FIG. 13 shows the chart flow continuation 503 from FIG. 12 that ends the process, also chart flow continuation 501 from FIG. 12 on the alert 185 or no alert 185 and if no alert 185 then the chart flow continuation 502 back to FIG. 12 goes to iterate the machine 55 video read process, if there is a patient 100 alert 185, then appropriate action is taken by the medial practitioner 90 after which the system is reset and returns to chart flow 502 in going from FIG. 13 to FIG. 12 to continue to read the machine 55 display.

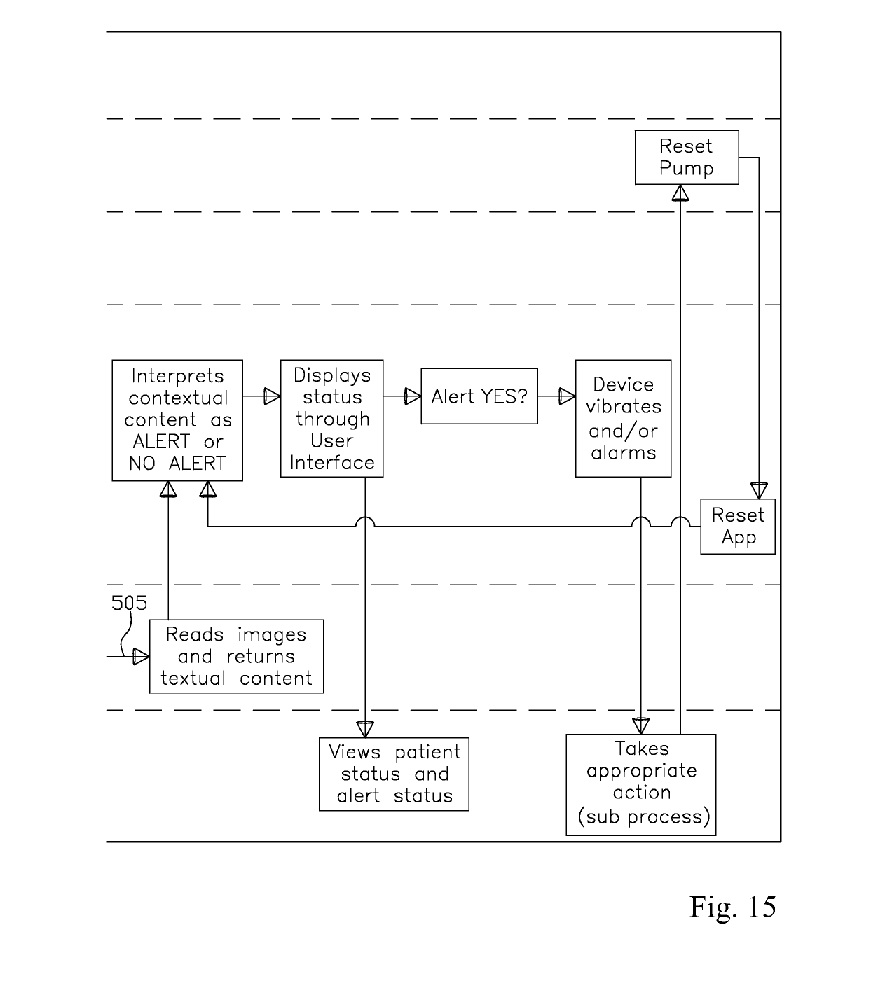

Further, FIG. 14 is the first Figure in a summary flow chart that includes FIGS. 14 and 15, that starts in the upper left had corner of FIG. 14 with the patient 100 who is attached to the IV pump 55 or any other machine 55 that could include in the medial field a Tube Feeding Pump, a Ventilator, a Cardiac Monitor, a Cooling Machine, a Bispectral Index (BIS) Monitor, an Anesthesia Monitor, a Seizure Monitor or any other like machine 55. Wherein in FIG. 14 the machine 55 is initiated to operate, next the present invention of the Remote Notification System 50 reads the video via a camera 57 with integral OCR 59 or data feed from the output screen of the machine 55 or data from internally in the machine 55, links the machine 55 output to a particular patient 100 and wirelessly in an encrypted manner sends the output via chart flow 505 to FIG. 15.

Next, FIG. 15 starts at chart flow 505 for the generation of textual content from the OCR 59 wherein it is determined in the tablet/phone 85 app 150 if an alert 185 is needed or not that continues to the tablet/phone 85 display for viewing by the medical practitioner 90, and if an alert 185 is needed, an alarm 185 can be activated to inform the medial practitioner 90 to take action as appropriate, wherein the medical practitioner 90 can reset the app 150 in the tablet/phone 85 display, at which point the textual content is continued to be read for an alert 185 or no alert 185 in the tablet/phone 85 app 150.

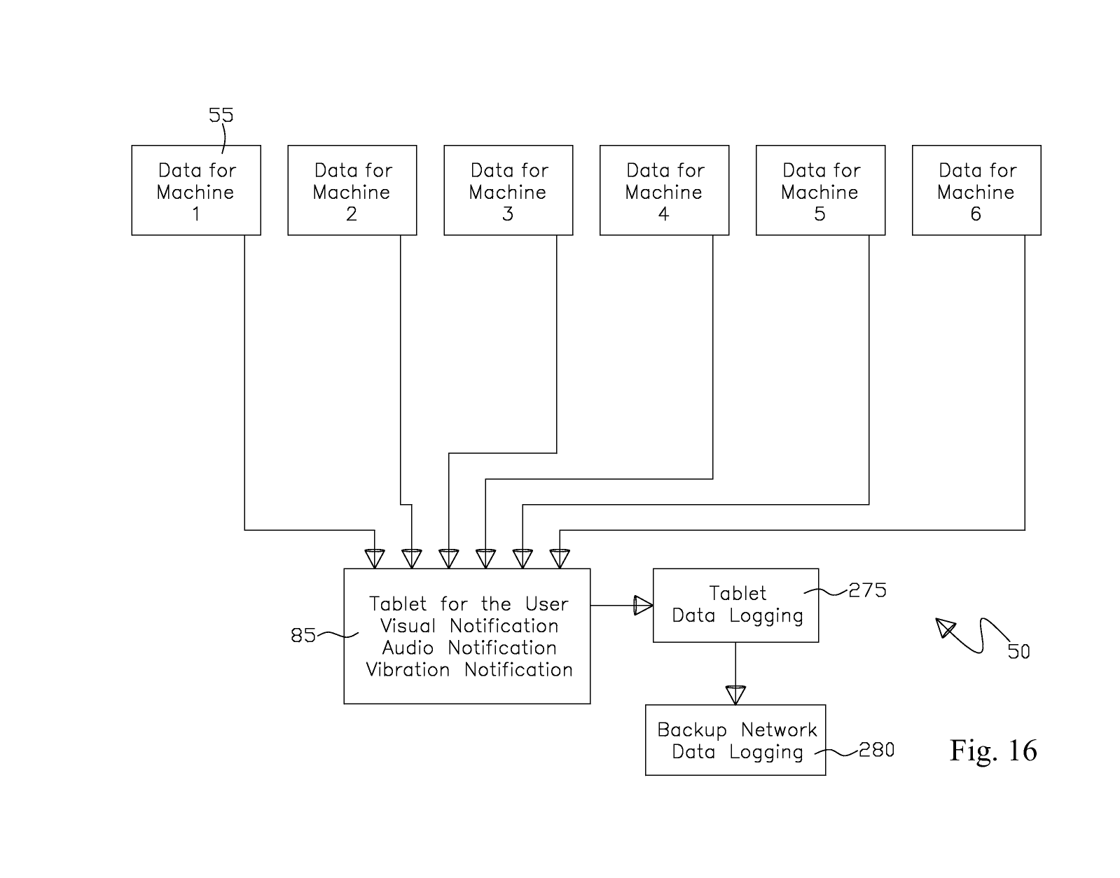

Continuing, FIG. 16 shows a summary diagrammatic schematic layout of the present invention of the remote notification system 50 using any type of general machine 55 with the present invention having an output wireless signal from the machine 55 using either a camera 57 with OCR to read a machine 55 perceptible output screen with the sensing control circuit 120 or directly from the machine 55 itself send the wireless signal including the machine perceptible output to the tablet/phone 85, also shown is machine 55 data logging and network backup for machine 55 data based upon the machine perceptible output.

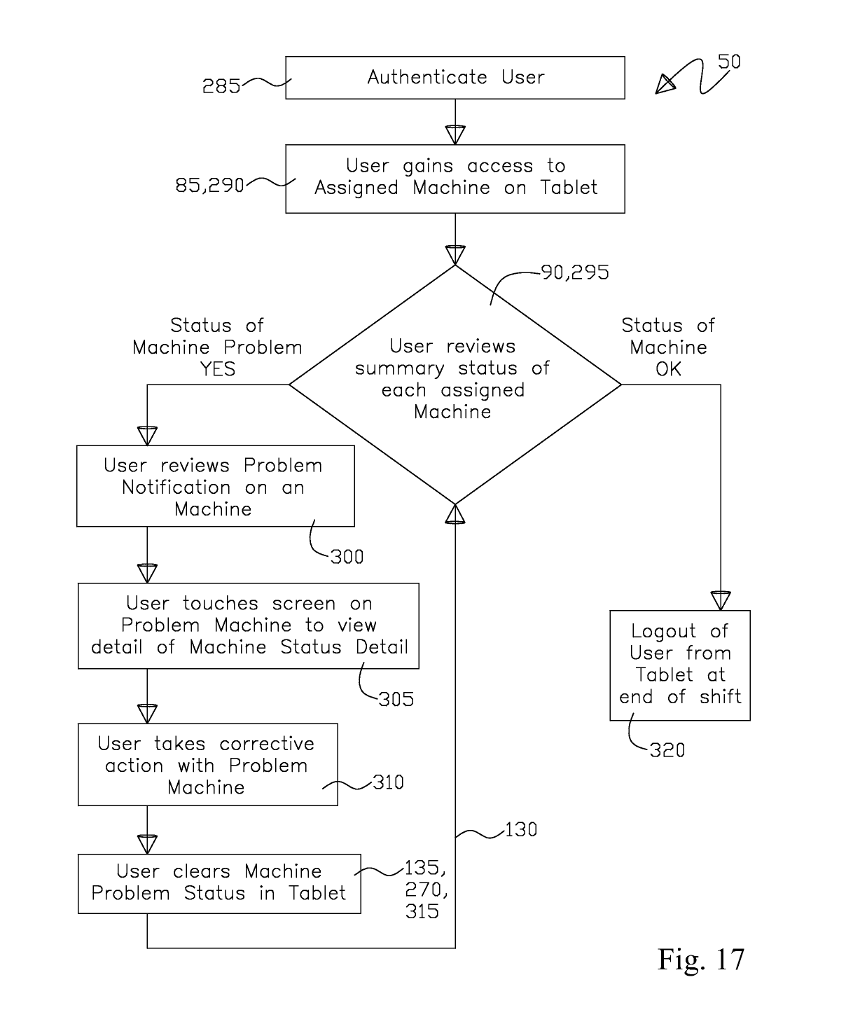

Further, FIG. 17 is a diagrammatic flow chart showing the process that the user 90 goes through in utilizing the present invention of the wireless remote notification system 50, wherein firstly the user 90 is authenticated on the tablet or phone 85 as in a conventional login. Next shown in FIG. 17, the user 90 gains access to their assigned machine 55 with a summary display of the machine 55 group, wherein each machine's 55 alarm 185 status for an abnormal perceptible output is determined given the operable ranges of each of the machine 55 perceptible outputs that is displayed in the summary display. In FIG. 17, if the machine 55 alarm 185 indicates YES for a problem, then the user 90 touches the particular alarmed machine 55 identification on the summary display 170 of the tablet/phone 85 which leads to a detailed display for the particular alarmed machine 55. Wherein, in FIG. 17 the user 90 will have detailed information of the exact nature of that particular machine's 55 alarmed 185 condition, then the user 90 takes corrective action to clear the root of the alarm 185 condition for the associated machine 55, at which point the user 90 clears the alarm 185 on the tablet or phone 85 display, in the case of the machines 55 not having alarms 185, then the user 90 would log out at the end of their shift.

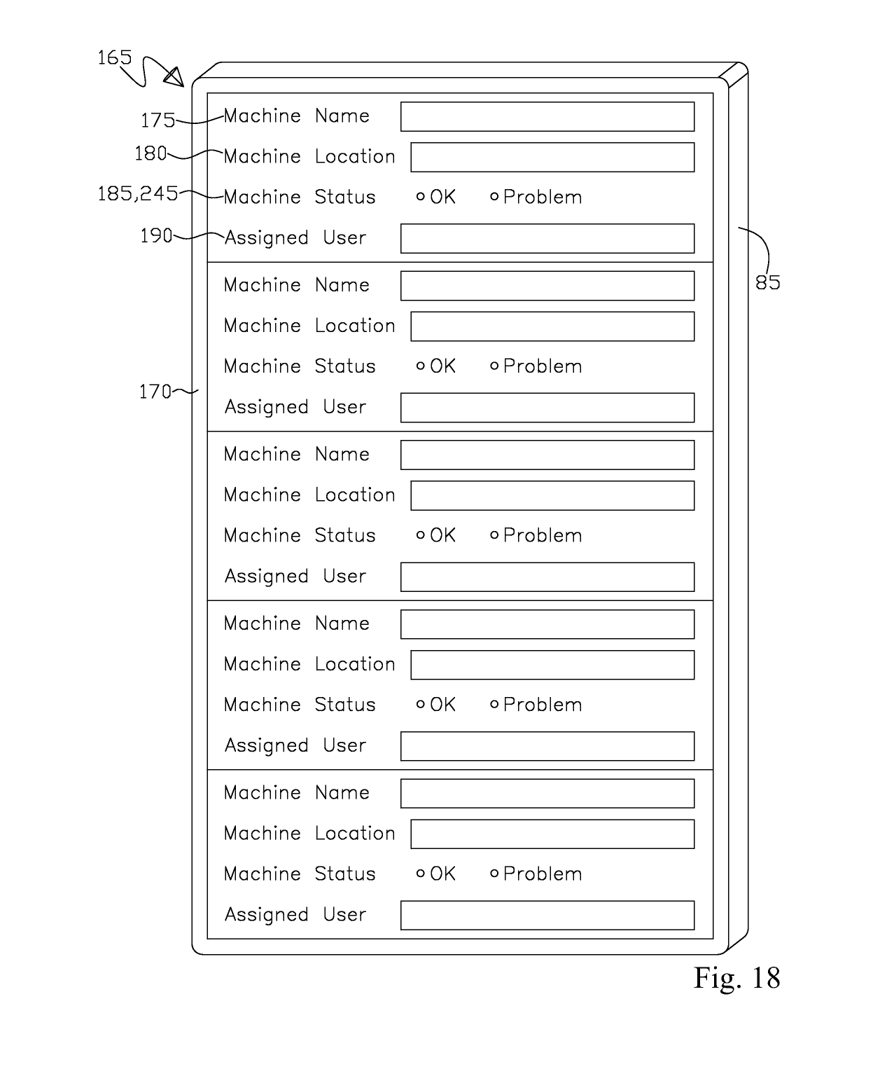

Next, FIG. 18 is a screen shot view of the summary display 170 for the tablet or phone 85 display of the user's 90 assigned machine 55 group wherein the summary display 170 gives a snapshot look at each one of the machine's 55 basic information that includes machine 55 name, machine 55 location, the assigned user 90, and a summary alarm 185 status for that machine 55.

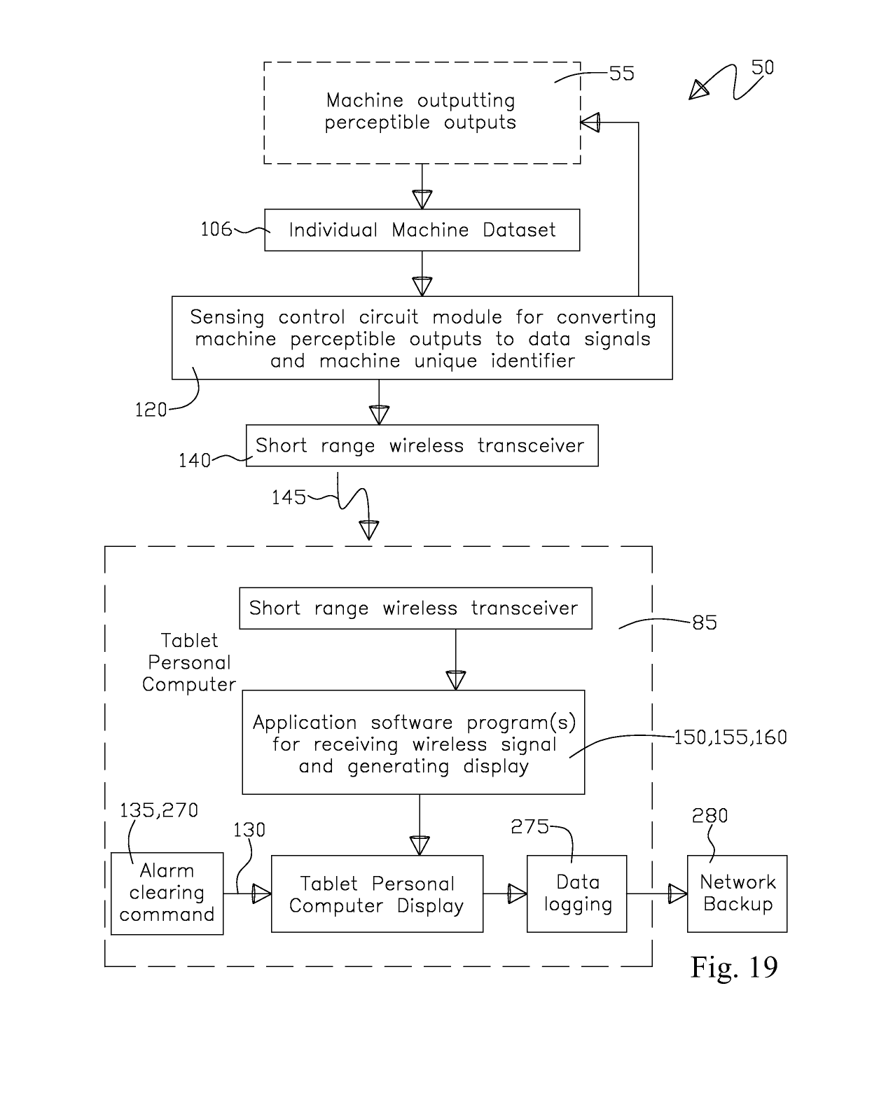

Continuing, FIG. 19 shows a diagrammatic schematic of the wireless remote notification system 50 with the data flow shown, starting with the machine 55 outputting perceptible outputs being in conjunction with an individual machine 55 dataset 106 that is used by the sensing control circuit 120 to output through the wireless transceiver 140 to the wireless tablet or phone 85 that can receive the output wireless signal and the tablet or phone 85 having application programs 150 or app(s) to generate screen displays. Further, shown in FIG. 19 is the alarm 185 clearing command that resets the display from the alarm 185 condition to the prior machine 55 perceptible outputs being displayed with acceptable perceptible output operating ranges. In addition, in FIG. 19 shown is the machine 55 data logging, and the machine 55 data backup on the network, with machine 55 data being defined as perceptible outputs being displayed with acceptable perceptible output operating ranges.

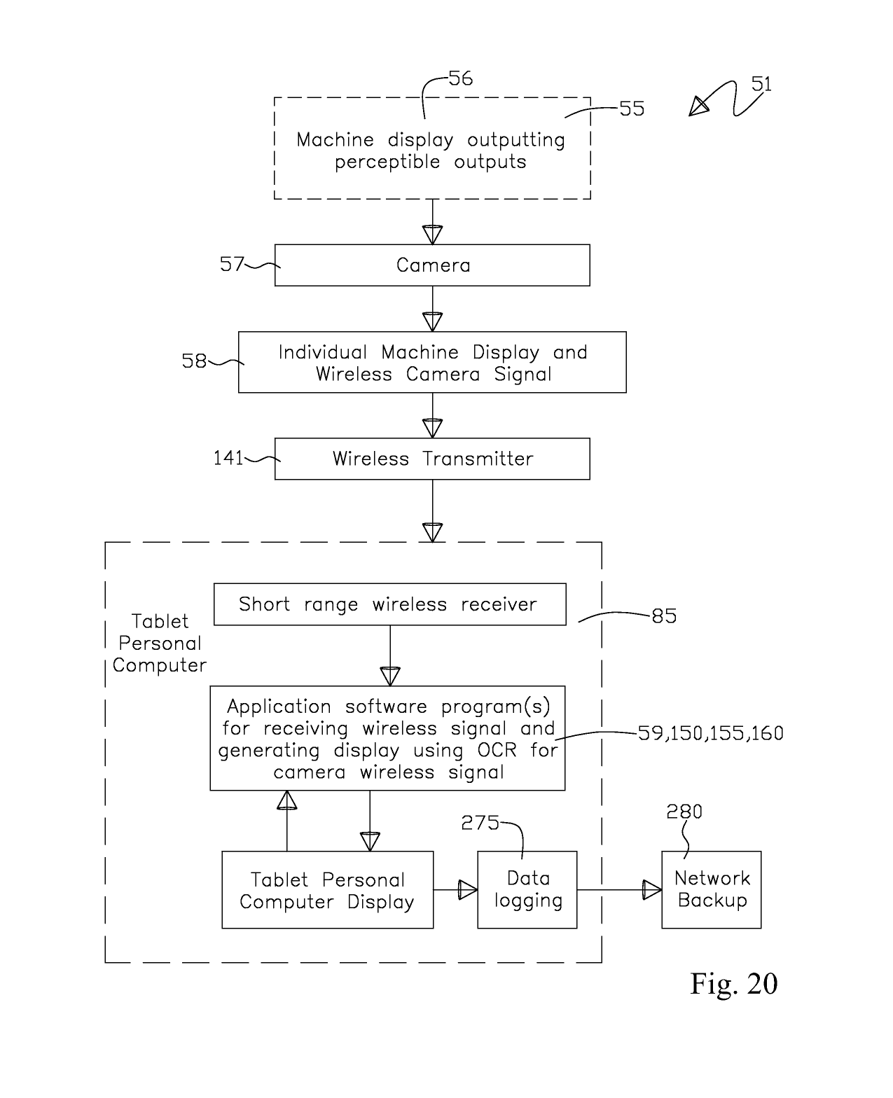

Moving forward, FIG. 20 shows a diagrammatic schematic of the wireless remote notification system starting with the machine 55 having a display outputting perceptible outputs being in conjunction with the camera 57 that outputs an individual machine 55 dataset 106 from the machine 55 display screen to output through the wireless transmitter 141 to the tablet or phone 85 that can receive the output wireless signal 58 and has application programs 150 that utilize Optical Character Recognition (OCR) 59 from the camera 57 wireless screen display image to generate displays in the wireless capable tablet or phone 85, in addition to the machine 55 data logging, and the machine 55 data backup on the network.

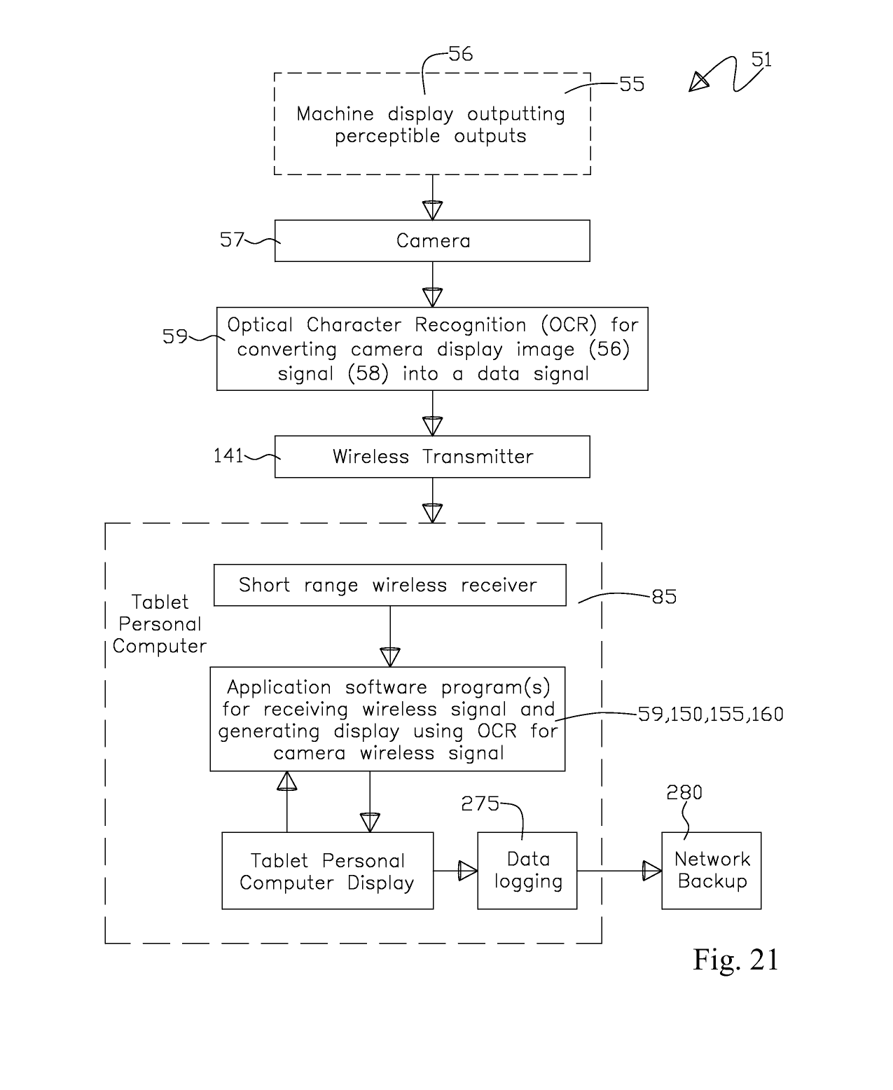

In addition, FIG. 21 shows a diagrammatic schematic of the wireless remote notification system 50, starting with the machine 55 having a display outputting perceptible outputs being in conjunction with the camera 57 that integrates and has application programs that utilize Optical Character Recognition (OCR) 59 from the camera 57 wireless screen display image. Thus, FIG. 21 shows the camera 57 to generate the wireless signal that outputs an individual machine 55 dataset 106 from the machine 55 display screen to the wireless tablet or phone 85 that can receive the output wireless signal to generate displays in the wireless capable tablet personal or phone 85, in addition to the machine 55 data logging, and the machine 55 data backup on the network.

Broadly, in referring to FIGS. 3 through 15, the present invention of the wireless remote notification system 50 is for use by the medical practitioner 90 having the wireless capable tablet personal computer 85, for the medical practitioner 90 to attend to each one of a positionally fixed group of multiple patients 100 with each patient utilizing an uniquely identified intravenous fluid pump 55, as best shown in FIGS. 1 to 3. The intravenous fluid pump 55, monitors treatment session time 210, intravenous fluid 71 gas content 215, intravenous fluid 71 pressure 225, intravenous fluid flow-rate 235, and includes an alarm 185 for an abnormal intravenous fluid 71 condition. The wireless remote notification system 50 also includes an individual patient dataset 105 that has a plurality of patient 100 parameters that include but are not limited to the patient 100 name 175, the patient 100 seat number 180, the patient 100 scan bar code 265, the intravenous treatment fluid(s) 205 as a group, or the intravenous treatment fluid individually 71, treatment session time 210, the volume 211 of intravenous treatment fluid 71 per treatment session, and the assigned 190 medical practitioner 90, see FIGS. 6 and 7.

Further included in the wireless remote notification system 50 is a sensing control circuit 120 that is configured to receive the individual patient dataset 105 and link to the uniquely identified intravenous fluid pump 55 which monitors the received treatment session time 210, also the intravenous fluid 71 gas content 215, the intravenous fluid 71 pressure 225, the intravenous fluid 71 flow-rate 235, and to alarm 185 for any of the previously identified abnormal intravenous fluid 71 conditions. Also, the sensing circuit 120 is configured to create an output signal to the wireless transceiver 140 of the individual patient 100 dataset 105, and link to the uniquely identified intravenous fluid pump 55, and the received treatment session time 210, plus the dynamic factors of the intravenous fluid 71 gas content 215, the intravenous fluid 71 pressure 225, the intravenous fluid 71 flow-rate 235, and alarm 185 for any of the previously identified abnormal intravenous fluid 71 conditions. Further, the sensing control circuit 120 is also configured to receive an alarm 185 clearing signal 130 and to deactivate 135 the alarm 185, see FIGS. 6 and 7.

In addition, included in the wireless remote notification system 50 is a wireless transceiver 140 that is in electrical communication with the sensing control circuit 120, the wireless transceiver 140 is configured to receive and wirelessly transmit in an output wireless signal 145 the individual patient dataset 105 and link to the uniquely identified 260 intravenous fluid pump 55. Also, the received treatment session time 210, the intravenous fluid 71 gas content 215, the intravenous fluid 71 pressure 225, the intravenous fluid 71 flow-rate 235, and alarm 185 for any of the previously identified abnormal intravenous fluid 71 conditions. Further, the wireless transceiver 140 is configured to receive a wireless alarm 185 clearing signal 125, and transmit the alarm 185 clearing signal 125 to the sensing control circuit 120, and further to the intravenous fluid pump 55, see FIGS. 6 and 7.

Further, in the wireless remote notification system 50 there are included one or more programs 150, wherein the one or more programs 150 are stored in a memory 155 of the tablet personal computer 85 and executed by one or more processors 160 of the tablet personal computer 85, see FIG. 7. These one or more programs 150 having instructions for producing a visual display 165 on the tablet personal computer 85 from the output wireless signal 145 of the individual patient 100 dataset 105, and link to the uniquely identified intravenous fluid pump 55, again see FIG. 7. Looking at FIGS. 5 and 6, the visual display 165 including the received treatment session time 210, the intravenous fluid 71 gas content 215, the intravenous fluid 71 pressure 225, the intravenous fluid 71 flow-rate 235, and alarm 185 for any of the previously identified abnormal intravenous fluid 71 conditions. Further, program 150 instructions are to facilitate the medical practitioner 90 selectively inputting an alarm 185 clearing command 270 after correcting the alarmed 185 abnormal intravenous fluid 71 root condition in the patient 100, thus disposing of the alarm 185. This results in the wireless alarm 185 clearing signal 125 generated from the tablet personal computer 85 and received by the wireless transceiver 140 and further communicated to the sensing control circuit 120 and further to the intravenous fluid pump 55 to minimize alarms 185 at the intravenous fluid pump 55 to minimize patient 100 aggravation due to excessive alarms 185 activating, see FIGS. 6 and 7.

Referring in particular to FIGS. 16 to 21, for the wireless remote notification system 50 which is for use by a user 90 having a wireless capable tablet or phone 85 personal computer, for the user 90 to attend to each one of a positionally fixed group of multiple machines 55 that each have a perceptible output. The wireless remote notification system 50 including an individual machine 55 dataset 106 that includes a plurality of machine 55 parameters that have machine 55 name, machine 55 location, machine 55 scan bar code for specific identification, machine 55 perceptible outputs, acceptable operational ranges for the machine 55 perceptible outputs, and the assigned user 90 or someone who monitors the machine(s) 55.

Also included in the wireless remote notification system 50 is a sensing control circuit 120 configured to receive the individual machine 55 dataset 106 and link to the uniquely identified machine 55 and also receive the perceptible outputs. The sensing circuit 120 is also configured to output the individual machine 55 dataset 106 and link to the uniquely identified machine 55 and the perceptible outputs. Further included in the wireless remote notification system 50 is a wireless transceiver 140 in electrical communication with the sensing control circuit 120, the wireless transceiver 140 is configured to receive and wirelessly transmit in an output wireless signal the individual machine 55 dataset 106 and link to the uniquely identified machine 55 and the perceptible outputs, further the wireless transceiver 140 is configured to receive a wireless alarm clearing signal 130 and transmit the alarm clearing signal 130 to the sensing control circuit 120.

In addition, in the wireless remote notification system 50 includes one or more programs 150, wherein the one or more programs 150 are stored in a memory 155 of the tablet or phone 85 personal computer and executed by a one or more processors 160 of the tablet or phone 85 personal computer. The one or more programs 150 include instructions for producing a visual display on the tablet personal computer or phone 85 from the output wireless signal of the individual machine 55 dataset 106 and link to the uniquely identified machine 55, the visual display including the perceptible outputs and the acceptable operational ranges for the machine 55 perceptible outputs with the visual display indicating the perceptible outputs operating within or outside of the acceptable operational ranges wherein an alarm 185 will alert the user 90 to the perceptible outputs operating outside of the acceptable operational ranges.

### CONCLUSION

Accordingly, the present invention of the remote notification system has been described with some degree of particularity directed to the embodiments of the present invention. It should be appreciated, though; that the present invention is defined by the following claims construed in light of the prior art so modifications or changes may be made to the exemplary embodiments of the present invention without departing from the inventive concepts contained therein.

1. A wireless remote notification system for use by a medical practitioner having a wireless capable tablet personal computer with a display screen, for the medical practitioner to attend to each one of a positionally fixed group of multiple patients with each patient utilizing an uniquely identified intravenous fluid pump that monitors treatment session time, intravenous fluid gas content, intravenous fluid pressure, intravenous fluid flow-rate, and includes an alarm for an abnormal intravenous fluid condition, said system comprising:
(a) an individual patient dataset that initially includes a plurality of patient parameters that includes name, seat number, scan bar code, intravenous treatment fluid, treatment session time, volume of intravenous treatment fluid per treatment session, and assigned medical practitioner;
(b) a sensing control circuit configured to receive said individual patient dataset and link to the uniquely identified intravenous fluid pump, further said sensing control circuit receives the received treatment session time, the intravenous fluid gas content, the intravenous fluid pressure, the intravenous fluid flow-rate, and the alarm, said sensing control circuit is also configured to output said individual patient dataset and link to the uniquely identified intravenous fluid pump and the received treatment session time, the intravenous fluid gas content, the intravenous fluid pressure, the intravenous fluid flow-rate, and the alarm, said sensing control circuit is further configured to receive an alarm clearing signal and to deactivate the alarm;
(c) a wireless transceiver in electrical communication with said sensing control circuit, said wireless transceiver is configured to receive and wirelessly transmit in an output wireless signal of said individual patient dataset and link to the uniquely identified intravenous fluid pump and the received treatment session time, the intravenous fluid gas content, the intravenous fluid pressure, the intravenous fluid flow-rate, and the alarm, further said wireless transceiver is configured to receive a wireless alarm clearing signal and transmit said alarm clearing signal to said sensing control circuit and further to the intravenous fluid pump;
(d) one or more programs, wherein said one or more programs are stored in a memory of the tablet personal computer that is configured to receive said output wireless signal, said one or more programs are executed by a one or more processors of the tablet personal computer, said one or more programs including; and
(d)(i) instructions for producing a visual display on the tablet personal computer from said output wireless signal of said individual patient dataset and link to the uniquely identified intravenous fluid pump, said visual display including the received treatment session time, the intravenous fluid gas content, the intravenous fluid pressure, the intravenous fluid flow-rate, and the alarm, further instructions to facilitate the medical practitioner selectively inputting an alarm clearing command after correcting the alarmed abnormal intravenous fluid condition in the patient thus disposing of the alarm, resulting in said wireless alarm clearing signal generated from the tablet personal computer and received by said wireless transceiver and further communicated to said sensing control circuit and further to the intravenous fluid pump.

2. A wireless remote notification system for use by a medical practitioner having a wireless capable tablet personal computer with a display screen, for the medical practitioner to attend to each one of a positionally fixed group of multiple patients with each patient utilizing an uniquely identified intravenous fluid pump having a display screen that monitors treatment session time, intravenous fluid gas content, intravenous fluid pressure, intravenous fluid flow-rate, and includes an alarm for an abnormal intravenous fluid condition, said system comprising:
(a) an individual patient dataset that initially includes a plurality of patient parameters that includes name, seat number, scan bar code, intravenous treatment fluid, treatment session time, volume of intravenous treatment fluid per treatment session, and unique intravenous fluid pump identifier;
(b) a video camera that is positionally affixed to the uniquely identified intravenous fluid pump having the display screen, such that operationally the camera observes the intravenous fluid pump display screen, wherein said video camera outputs a video signal that includes said individual patient dataset from the intravenous fluid pump display;
(c) a wireless transmitter in electrical communication with said video camera, said wireless transmitter is configured to receive said video signal and wireless sly transmit in an output wireless signal that includes said individual patient dataset;
(d) one or more programs, wherein said one or more programs are stored in a memory of the tablet personal computer that is configured to receive said output wireless signal, said one or more programs are executed by a one or more processors of the tablet personal computer, said one or more programs including; and
(d)(i) instructions for producing a visual display on the tablet personal computer from said output wireless signal of said initial individual patient dataset and link to the uniquely identified intravenous fluid pump, and further said visual display including the received treatment session time, the intravenous fluid gas content, the intravenous fluid pressure, the intravenous fluid flow-rate, and the alarm.

3. A wireless remote notification system for use by a user having a wireless capable tablet personal computer with a display screen, for the user to attend to each one of a positionally fixed group of multiple machines that each have a perceptible output, said system comprising:
(a) an individual machine dataset that includes a plurality of machine parameters that have machine name, machine location, machine scan bar code, machine perceptible outputs, acceptable operational ranges for said machine perceptible outputs, and assigned user;
(b) a sensing control circuit configured to receive said individual machine dataset and link to the uniquely identified machine and also receive said perceptible outputs, said sensing circuit is also configured to output said individual machine dataset and link to the uniquely identified machine and said perceptible outputs;
(c) a wireless transceiver in electrical communication with said sensing control circuit, said wireless transceiver is configured to receive and wirelessly transmit in an output wireless signal said individual machine dataset and link to the uniquely identified machine and said perceptible outputs;
(d) one or more programs, wherein said one or more programs are stored in a memory of the tablet personal computer that is configured to receive said output wireless signal, said one or more programs are executed by a one or more processors of the tablet personal computer, said one or more programs including; and
(d)(i) instructions for producing a visual display on the tablet personal computer from said output wireless signal of said individual machine dataset and link to the uniquely identified machine, said visual display including said perceptible outputs and said acceptable operational ranges for said machine perceptible outputs with said visual display indicating said perceptible outputs operating within or outside of said acceptable operational ranges wherein an alarm will alert the user to said perceptible outputs operating outside of said acceptable operational ranges.
